(19) United States
(12) Patent Application Publication
(10) Pub. No.: US 2007/0160321 A1
(43) Pub. Date: Jul. 12, 2007

(54) MONOLITHIC MEMS-BASED WAVELENGTH-SELECTIVE SWITCHES AND CROSS CONNECTS

(75) Inventors: Ming-Chiang Wu, Moraga, CA (US); Chao-Hsi Chi, Taiping, Taichung (TW)

Correspondence Address: JOHN P. O'BANION;O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA, Oakland, CA (US)

(21) Appl. No.: 11/566,184

(22) Filed: Dec. 1, 2006

Related U.S. Application Data
(60) Provisional application No. 60/741,497, filed on Dec. 1, 2005.

(51) Int. Cl. G02B 6/28; G02B 6/34

(52) U.S. Cl. 385/24; 385/37

(57) ABSTRACT

Wavelength-selective 1×N switches (WSSs) and N×N cross-connects (WSXCs) are described which are fabricated as monolithic or hybrid devices. In a preferred embodiment, the optic ports, dispersion elements, and collimating elements are formed on a single monolithic substrate. A micromirror and actuator are either fabricated within the substrate or a separate micromirror is utilized forming a hybrid WSS or WSXC. The optical elements can be formed in an opaque substrate layer (e.g., silicon, SOI, and so forth) or in an optically transparent layer of a PLC material (e.g., silica-on-silicon). Embodiments describe the use of linear and rotary comb drives for actuating front surface mirrors, or solid-immersion micromirrors (SIMs). The switching devices reduce system footprint while reducing or eliminating the need for alignment of the optical elements.

### CROSS-REFERENCE TO RELATED APPLICATIONS

This application claims priority from U.S. provisional application serial number 60/741,497 filed on Dec. 1, 2005, incorporated herein by reference in its entirety.

### STATEMENT REGARDING FEDERALLY SPONSORED RESEARCH OR DEVELOPMENT

This invention was made with Government support under DARPA Grant No. MDA972-02-1-0020. The Government has certain rights in this invention.

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to optical switches, and more particularly to monolithic wavelength-selective switches.

2. Description of Related Art

Wavelength-selective switches (WSSs) and wavelength-selective cross-connects (WSXCs) enable flexible and intelligent wavelength-division-multiplexed (WDM) networks. In addition, the use of integrated WSSs and WSXCs within networks can foster reduced operating costs. In a 1×N WSS, the wavelengths from the input port can be independently switched to any of N output ports. A WSXC allows switching of optical signals, on a wavelength selective basis, between N input ports and N output ports. Most of the WSSs and WSXCs reported to date are realized by free-space optical systems with either a micro-electro-mechanical-systems (MEMS) or a liquid crystal (LC) beam-steering array, or by utilizing silica-based planar lightwave circuits with cascaded 2×2 thermal optical switches. However, these implementations are costly, require precise alignment, have large footprints, and suffer from additional shortcomings.

Therefore, a need exists for an apparatus and method for performing wavelength-selective optical switching within a small monolithic device that does not require optical alignment. The present invention satisfies those needs, as well as others, and overcomes the deficiencies of previously developed optical switching devices.

### BRIEF SUMMARY OF THE INVENTION

In the present invention, wavelength-selective switches (WSSs) and wavelength-selective cross-connects (WSXCs), and related devices can be monolithically integrated on a single chip. According to an aspect of the invention, optical waveguides, microgratings, curved reflectors, as well as MEMS active switching micromirrors are monolithically fabricated on the same substrate, such as using a one-step etching process.

In a general embodiment of a 1×N WSS, the micromirror array is integrated at the focal plane of the focusing mirror for independent switching of the wavelength channels to the desired output waveguides. More particularly, in one embodiment, a 1×4 WSS for coarse WDM (CWDM) is fabricated on a 2×1.4-cm² chip. This WSS achieves a switching time of 0.5 msec with a fiber-to-fiber insertion loss of 11.7 dB.

In a general embodiment of a N×N WSXC, a plurality of monolithic N×1 WSSs are integrated with 1×N multi-mode interference (MMI) splitters on the same wafer. In one embodiment, a monolithic 4×4 WSXC is realized by integrating four 4×1 WSSs and four 1×4 MMIs with the need for fiber connections or external splitters. In one embodiment, a 90° waveguide bend and 90° waveguide crossing are employed to minimize insertion loss and crosstalk. In one embodiment, the 4×4 WSXC was fabricated with a chip area of 3.2×4.6 cm² and exhibited an insertion loss of 24 dB, inclusive of a 6-dB splitting loss. The WSXC supports unicast, multicast, and broadcast functions.

According to another aspect of the invention, a monolithic WSS is realized by integrating the micromirror with arrayed-waveguide gratings (AWGs) on a silicon-on-insulator (SOI) substrate, PLC material (e.g., silica on silicon), or similar optical substrate material preferably containing at least one silicon layer. In one embodiment, the WSS comprises a 1×8 optical switch on a hybrid PLC-MEMS platform. In one embodiment, the WSS is integrated with a microfabricated cylindrical lens, eliminating the need for external bulk lenses. In one embodiment, the fabricated 1×8 switch exhibits an insertion loss of 3.9±0.2 dB and an extinction ratio greater than 27 dB.

The invention is amenable to being embodied in a number of ways, including but not limited to the following descriptions.

One embodiment of the invention can be generally described as an apparatus for switching optical signals through a wavelength-selective switch (WSS), comprising: (a) an optical input port for receiving a wavelength division multiplexed (WDM) light beam; (b) at least one integrated dispersive element to demultiplex the WDM light beam for producing a plurality of demultiplexed light beams; (c) a plurality of optical output ports for transmitting multiplexed light beams; and (d) a plurality of integrated switching elements for redirecting each of said demultiplexed light beams to said optical output ports.

The WSSs can be utilized in combination to create wavelength-selective cross connect switches and other optical system elements.

The devices preferably include integrated collimating elements, such as curved mirrors, and may include folded mirrors for redirecting the optics, such as to reduce the footprint of the WSS.

The optical input and output ports are preferably fabricated as optical waveguides within the substrate, for example trenches within an optically opaque material (silicon, SOI, etc.), or as solid waveguides (e.g., trenches bounding a solid waveguide) in optically transparent material (silica-on-silicon, or other PLC materials). Preferably the remaining WSS components are also fabricated on the substrate, while separate micromirrors can be optionally utilized to form a hybrid device if desired.

Integrated micromirrors comprise front surface or SIM mirrors which are angularly driven by electrostatic actuators, such as linear or rotary comb-drives. A number of alternative mirror drive configurations are taught according to the invention.

The present invention can provide a number of beneficial aspects which can be implemented either separately or in any desired combination without departing from the present teachings.

An aspect of the invention provides for monolithic wavelength-selective switching (WSS).

Another aspect of the invention is to provide wavelength-selective switches (WSS) having switching times under one millisecond.

Another aspect of the invention is to provide wavelength-selective switches (WSS) capable of being fabricated for operation in the infrared, near-infrared and visible portions of the electromagnetic spectrum.

Another aspect of the invention is to provide a WSS configuration that can be implemented in a limited space with largely conventional fabrication processes.

Another aspect of the invention is to provide a WSS having integral waveguides.

Another aspect of the invention is to provide a WSS having integral large dimensional rib waveguides.

Another aspect of the invention is to provide a WSS which can be fabricated on SOI, PLC material (e.g., silica on silicon (SOS)), or similar optical substrate, preferably comprising at least one silicon layer.

Another aspect of the invention is to provide a WSS which is compatible with SOI fabrication techniques.

Another aspect of the invention is to provide a WSS as a PLC device.

Another aspect of the invention is to provide a WSS having integrated dispersive elements and integrated switching elements for redirecting light beams between optical input and output ports.

Another aspect of the invention is to provide a WSS having optical ports comprising integral waveguides.

Another aspect of the invention is to provide a WSS having one or more integrated dispersive elements including integrated diffraction gratings fabricated on the same substrate as the optical waveguides of the input and output ports.

Another aspect of the invention is to provide a WSS having integrated diffraction gratings implemented as arrays of trenches fabricated on the same substrate as the optical waveguides of the input and output ports.

Another aspect of the invention is to provide a WSS having an integrated array of switching elements comprising moveable mirrors fabricated on the same substrate as the optical waveguides of the input and output ports.

Another aspect of the invention is to provide a WSS with mirror assemblies incorporating anti-reflective coatings.

Another aspect of the invention is to provide a WSS having an integrated array of moveable mirrors comprising electrostatic actuators, such as rotary comb-drives.

Another aspect of the invention is to provide a WSS having integrated means for collimating light beams fabricated on the same substrate as the optical waveguides of the input and output ports.

Another aspect of the invention is to provide a WSS having integrated means for focusing and/or reflecting light beams, such as collimating reflectors, focusing reflectors and folding reflectors.

Another aspect of the invention is to provide a WSS in which mirrors are fabricated using angled deposition, such as an angled evaporation process.

Another aspect of the invention is to provide a WSS that does not significantly degrade the optical signals being switched.

Another aspect of the invention is to provide a WSS which can be incorporated within various WSXC architectures.

Another aspect of the invention is to provide a WSS which can be monolithically integrated with other optical devices.

Another aspect of the invention is to provide a WSS in which bent waveguides incorporate offsets to reduce insertion losses.

Another aspect of the invention is to provide a WSS in which bends in the waveguides are shaped according to adiabatic profiles.

Another aspect of the invention is to provide optical splitters, and other optical elements, utilizing tapered waveguides to improve coupling and reduce sensitivity to linewidth variation.

Another aspect of the invention is to provide a PLC-MEMs optical switch hybrid having waveguides on a PLC material that couple through a free propagation slab region to a cylindrical mirror at the edge of the PLC for coupling to an off-chip MEMs micromirror.

Another aspect of the invention is to provide a method for fabricating an integrated cylindrical lens on a PLC substrate.

Another aspect of the invention is to provide a hybrid WSS utilizing array-waveguide gratings (AWGs) and hybrid optical switches.

Another aspect of the invention is to provide a monolithic WSS utilizing array-waveguide gratings (AWGs) and integrated micromirror optical switches.

Another aspect of the invention is to provide a WSS utilizing folded and unfolded reflector configurations.

Another aspect of the invention is to provide a uni-directional mirror assembly actuated by a voltage applied between stationary and movable sets of comb fingers.

Another aspect of the invention is to provide a bi-directional mirror assembly actuated by a voltage applied between two sets of stationary comb fingers and a movable set of comb fingers.

Another aspect of the invention is to provide a lateral mirror assembly drive configuration in which a moving comb is held between springs whose motion is coupled to a movable mirror assembly.

Another aspect of the invention is to provide a mirror assembly utilizing serpentine springs for retaining the structure on which the movable combs are attached.

Another aspect of the invention is to provide a lateral mirror assembly having an actuator width approximately equal to the width of the mirror being driven, wherein a linear array of adjacent mirrors can be fabricated.

Another aspect of the invention is to provide a mirror assembly configured using solid-immersion reflectivity.

Another aspect of the invention is to provide a mirror assembly having a curved front surface to maintain a constant air-gap irrespective of actuation angle.

Another aspect of the invention is to provide a mirror assembly having a curved PLC front surface and reflective rear-surface with solid immersion reflectivity.

Another aspect of the invention is to provide monolithic optical switching elements which can be combined into monolithic devices, and interconnected into optical systems.

Another aspect of the invention is to provide monolithic optical switching elements which can be stacked into three-dimensional arrangements.

Another aspect of the invention is to provide monolithic optical switching elements which can be stacked into three-dimensional arrangements, and cross-coupled using butt connections, with other optical elements.

Another aspect of the invention is to provide optical switching elements which can be integrated into different network configurations, such as OADM (ring), ROADM (ring), Mesh networks, WSSs, and WSXC and combinations thereof.

A still further aspect of the invention is to provide monolithic switching components which can be integrated into or couple to intelligent optical wavelength-division-multiplexed (WDM) networks.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic of a 1×4 wavelength selective switch (WSS) according to an aspect of the present invention, showing integration of collimators, focusing reflector, folding reflector, and micromirror array in a monolithic device.

FIG. 2 is a detailed schematic view of the collimating reflector and micro-grating within the WSS of FIG. 1.

FIG. 3 is a schematic of the 4-f confocal configuration of the WSS of FIG. 1.

FIG. 4 is a graph of simulated diffraction loss as a function of the gap for various slab thicknesses.

FIG. 5 is a schematic of sidewall angle effect in optical components such as gratings, parabolic reflectors, and folding reflectors fabricated according to aspects of the present invention.

FIG. 6 is a graph of simulated optical insertion loss for slab thickness of 2, 5, and 10 μm.

FIG. 7A-7Q are a series of schematics illustrating a fabrication process for a mirror device fabricated on a silicon-on-insulator (SOI) wafer, according to an aspect of the present invention.

FIG. 8A-8C are SEM images of observed sidewall angles in response to an increasing gas flow of NF₃, according to an aspect of the present invention.

FIG. 9A-9B are SEM images of etched sidewall roughness before and after hydrogen annealing, according to an aspect of the present invention.

FIG. 10A-10B are SEM images of triangular grating elements before and after hydrogen annealing, according to an aspect of the present invention.

FIG. 11-12 are schematics of a straight-on mirror coating process using standard evaporation, according to an aspect of the present invention.

FIG. 13-14 are schematics of an angled mirror coating process using standard evaporation, according to an aspect of the present invention.

FIG. 15A-15D are images (photograph and SEM) of a fabricated WSS device, according to an aspect of the present invention.

FIG. 16 is a bar graph of fiber-to-fiber crosstalk for the fabricated 1×4 WSS, according to an aspect of the present invention.

FIG. 17 is a graph of switching time for the 1×4 WSS, according to an aspect of the present invention.

FIG. 18 is a schematic of an experimental setup for testing the 1×4 WSS, according to an aspect of the present invention.

FIG. 19A-19B are images of eye diagrams (traces) as seen on an oscilloscope for the 1×4 WSS fabricated according to an aspect of the present invention.

FIG. 20A-20F are schematics of test structures utilized to test optical insertion loss and characterize integrated optical components according to an aspect of the present invention.

FIG. 21 is a schematic of a beam splitting embodiment according to an aspect of the present invention.

FIG. 22 is an image of output from the beam splitter of FIG. 21, showing dispersing a beam into multiple wavelengths.

FIG. 23-24 are schematics of WSXC architectures utilizing a plurality of monolithic WSS devices according to aspects of the present invention.

FIG. 25 is a schematic of a monolithic 4×4 WSXC, according to an aspect of the present invention, shown with four 4×1 WSSs and four 1×4 splitters interconnected on the same SOI wafer.

FIG. 26 is a schematic of a splitter utilized in the 4×4 WSXC of FIG. 25.

FIG. 27 is a schematic of waveguide bending as utilized in the 4×4 WSXC of FIG. 25.

FIG. 28 is a schematic of waveguide crossing as utilized in the 4×4 WSXC of FIG. 25.

FIG. 29 is an image of beam propagation method (BPM) simulation of a conventional 1×4 MMI splitter.

FIG. 30 is an image of beam propagation method (BPM) simulation of a tapered splitter, according to an aspect of the present invention.

FIG. 31 is a bar graph comparing BPM simulated splitting loss of the MMI with a W_{MMI}, of 40 μm and 41 μm with a conventional design and with a 1 μm linewidth variation.

FIG. 32 is a bar graph comparing BPM simulated splitting loss for the splitter of FIG. 30.

FIG. 33A-33B are images of simulated mode profiles for straight and bent waveguides, according to an aspect of the present invention.

FIG. 34 is a schematic of a waveguide bend configured with offsets according to an aspect of the present invention.

FIG. 35 is a graph of transition loss for bent waveguide of FIG. 34, showing loss with respect to offset value changes.

FIG. 36 is a schematic of a waveguide configured with adiabatic bend radius according to an aspect of the present invention.

FIG. 37 is a schematic of waveguide crossing geometry.

FIG. 38 is an image of 2D FDTD simulation of a 90° waveguide crossing according to an aspect of the present invention.

FIG. 39A-39D are images (photograph and SEM) of a monolithic 4×4 WSXC fabricated according to an aspect of the present invention.

FIG. 40 is a bar graph of measured transmission loss for a static WSXC device with a fixed mirror, according to an aspect of the present invention.

FIG. 41 is a graph of spectral response for the monolithic 4×4 WSXC, according to an aspect of the present invention.

FIG. 42 is a graph of normalized transmission versus actuation voltage for the input ports on the 4×4 WSXC fabricated according to an aspect of the present invention.

FIG. 43 is a schematic of reflections arising from imperfect anti-reflective coatings.

FIG. 44 is a transfer curve plotted with actuation V², showing that x-axis mirror rotation angle is generally proportional to the square of actuation voltage.

FIG. 45A-45C are schematics of waveguide bending test structures, according to an aspect of the present invention.

FIG. 46 is a schematic of a hybrid PLC-MEMS 1×8 optical switch according to an aspect of the present invention.

FIG. 47 is a schematic of the slab region for the optical switch of FIG. 46.

FIG. 48 is a schematic of optical switches configured for illustrating the equivalent light path for a round-trip between optical switches according to an aspect of the present invention.

FIG. 49 is a graph of calculated beam width versus propagation distance for the configuration of FIG. 48.

FIG. 50A-H are a series of schematics illustrating the steps in fabricating an integrated cylindrical lens according to an aspect of the present invention.

FIG. 51 is an SEM image of a fabricated PLC according to an aspect of the present invention.

FIG. 52 is an SEM image of the cylindrical lens at the edge of the PLC chip in FIG. 51.

FIG. 53-58 are bar graphs of transmission performance for ports 2-7 respectively for the hybrid optical switch of FIG. 47.

FIG. 59 is a graph of wavelength dependent loss (WDL) for the PLC-MEMs switch fabricated according to an aspect of the present invention.

FIG. 60 are graphs of switching time measured between port 5 and port 6 of the PLC-MEMs fabricated according to an aspect of the present invention.

FIG. 61 is a schematic of an AWG-based 1×7 WSS fabricated according to an aspect of the present invention, shown using the hybrid optical switch of FIG. 47.

FIG. 62 is a schematic of the micromirror array and lensing utilized in FIG. 61.

FIG. 63 is a schematic of a monolithic WSS fabricated according to an embodiment of the present invention.

FIG. 64A-64B are schematics of unfolded and folded configurations of MEMs-based WSSs, according to an aspect of the present invention.

FIG. 65 is a schematic of a rotary comb-drive having unidirectional deflection, according to an embodiment of the present invention.

FIG. 66 is a schematic of a rotary comb-drive having bi-directional deflection, according to an embodiment of the present invention.

FIG. 67-68 are schematics of lateral stability issues for comb-drive actuators.

FIG. 69 is an SEM image of a unidirectional micromirror device fabricated on an SOI wafer, or portion thereof, according to an aspect of the present invention.

FIG. 70 is a graph of the DC characteristics of actuation response (mechanical angle) in response to actuation voltage for the unidirectional mirror assembly of FIG. 69.

FIG. 71A-71B are schematics of a lateral comb-drive micromirror according to an embodiment of the present invention, shown in both a non-deflected and deflected state.

FIG. 72A-72B are schematics representing the bending of a linear spring as utilized according to aspects of the present invention.

FIG. 73 is a schematic of a serpentine spring having a plurality of bends according to an aspect of the present invention.

FIG. 74 is a 3D bar graph of the theoretical spring constant kₓ for the spring of FIG. 73.

FIG. 75 is a 3D bar graph of spring constant ratio k_{y}/kₓ, for the spring of FIG. 73.

FIG. 76 is a schematic of a micromirror using linear actuation according to an embodiment of the present invention.

FIG. 77A-77C are SEM images of the fabricated micromirror represented in FIG. 76.

FIG. 78 is a graph of theoretical and measured DC characteristics of the micromirror of FIG. 76 and FIG. 77A-77C, respectively.

FIG. 79 is a schematic for a flat micromirror driven by a rotary comb-drive actuator according to an aspect of the present invention.

FIG. 80 is a schematic for an on-chip solid immersion micromirror (SIM) according to an embodiment of the present invention, showing reflections from the rear surface mirror.

FIG. 81 is a schematic of a unidirectional mirror assembly according to an aspect of the present invention, shown at both extends of travel.

FIG. 82A-82B is a cross-section of the unidirectional mirror of FIG. 81, showing how diffraction losses increase in response to widening of the air gap.

FIG. 83 is a schematic of a SIM as described in FIG. 80, shown at both an end and intermediate actuation-position to illustrate maintenance of a constant gap distance during rotation.

FIG. 84A is a graph of diffraction loss with respect to propagation distance, such as applied to unidirectional and SIM micromirrors fabricated according to embodiments of the present invention.

FIG. 84B is a graph of diffraction loss with respect to deflection angle for flat and solid immersion micromirrors (SIM) fabricated according to aspects of the present invention.

FIG. 85 is an SEM image of a solid immersion micromirror with 7-finger rotary comb-drive fabricated according to an embodiment of the present invention.

FIG. 86 is an SEM image of a solid immersion micromirror with 20-finger rotary comb-drive fabricated according to an embodiment of the present invention.

FIG. 87 is a graph of DC characteristics for the micromirrors shown in FIG. 85-86.

FIG. 88 is a graph of the stroboscopic measurement of resonant frequency for the SIM of FIG. 85 having a 7-finger comb-drive.

FIG. 89 is a schematic of an integrated optical switching chip according to an embodiment of the present invention, and shown in an arrangement for testing optical functionality.

FIG. 90A-90B are infrared (IR) images of the optical beam observed at the output ports of the SIM device of FIG. 89 to verify dynamic switching capability.

### DETAILED DESCRIPTION OF THE INVENTION

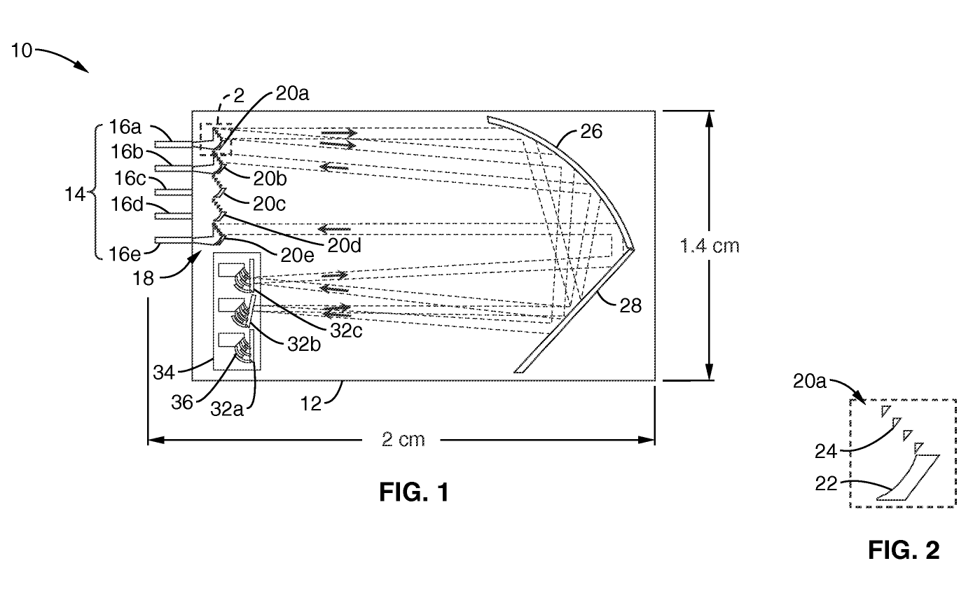

Referring more specifically to the drawings, for illustrative purposes the present invention is embodied in the apparatus generally shown in FIG. 1 through FIG. 90B. It will be appreciated that the apparatus may vary as to configuration and as to details of the parts, and that the method may vary as to the specific steps and sequence, without departing from the basic concepts as disclosed herein.

Silicon-Based Monolithic 1×N Wavelength-Selective Switches

FIG. 1-2 illustrates an example embodiment 10 of a monolithic WSS according to the present invention. While the discussion that follows describes a 1×4 WSS, it will appreciated that the device design, configuration and operation applies to a monolithic 1×N WSS and that the invention is not limited to a 1×4 WSS.

In the embodiment shown, the device is on substrate 12 and comprises input and output optical waveguides 14 with ports 16a, 16b, 16c, 16d, 16e (also referred to more generally as ports 1 through 5); collimating array 18 with elements 20a-20e each comprising a collimating reflector 22 and a micrograting 24 as shown in FIG. 2; a focusing reflector 26; a folding reflector 28; and a micromirror array 30 having elements 32a-32c matching to the CWDM (e.g., 1470-1610 nm) grids, such as with 20 nm spacing in this specific device. Each MEMs mirror 32a-32c in mirror array 30 comprises a base 34 and a movable element 36 which is actuated by a rotary comb-drive actuator. It will be appreciated that as an alternative multiple base sections may exist, or multiple movable sections, without departing from the teachings of the invention.

All components of the optical switch are preferably monolithically fabricated on the same substrate 12, such as a silicon-on-insulator (SOI), or similar substrate. The SOI platform is particularly attractive because it is compatible with SOI PLC as well as SOI-MEMS technologies. All optical paths are defined by photolithography and no optical alignment is necessary. Microgratings, parabolic reflectors, and folding reflectors fabricated on the device utilize total internal reflection (TIL). All silicon-air interfaces are preferably configured to reduce reflection, such as incorporating anti-reflection (AR)-coatings, such as with 180 nm thick low-stress silicon nitride (n=2.15). The micromirror elements in micromirror array 30 are preferably coated, such as with aluminum, to enhance reflectivity.

In the implementation shown, waveguide 16 a is used as the input port, and waveguide 16b-16e are used as the output ports. The input WDM signals are collimated by parabolic reflector 22 and demultiplexed by micrograting 24.

In this implementation, micrograting 24 comprises an array of deep-etched triangular elements blazed for the 14^{th} order diffraction at a 90° angle. The micromirror array 30 is preferably integrated at the focal plane of the focusing mirror for independent switching of the wavelength channels. The reflected light propagates in the reverse direction, where it is collimated by the focusing reflector, re-multiplexed by the micrograting, focused by the collimating reflector, and finally coupled to the desired output waveguides. Table 1 lists device parameters for the monolithic 1×4 WSS of FIG. 1.

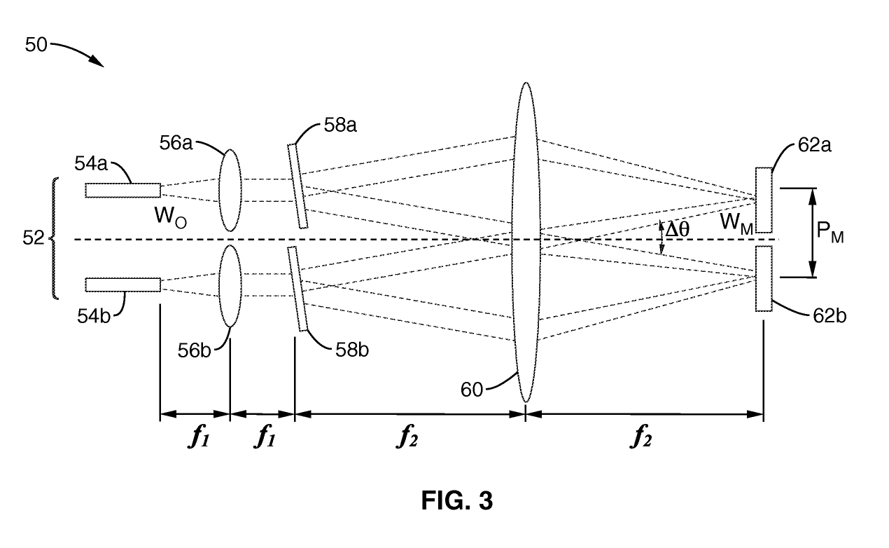

FIG. 3 illustrates that the implementation of the WSS of FIG. 1 is based on the 4-f confocal configuration and utilizes gratings as demultiplexers. Waveguides 52 are shown with ports 54a, 54b, optically coupled to collimating lenses 56a, 56b and gratings 58a, 58b, focusing lens 60, and micromirrors 62a, 62b. The collimating lens and the focusing lens are arranged in a 4-f confocal configuration for imaging from the input/output port to the micromirror at the focal plane of the focusing lens. The grating is inserted at the confocal position between the two lenses. The light is dispersed by the grating, and the focusing lens brings signals with the same wavelength to a point on the focal plane, where a micromirror is positioned for steering the signal to the desired output waveguide.

The 4-f confocal configuration ensures the geometric focusing position occurs at the minimum spot size of the Gaussian beam. This ensures the return beam has the same divergence angle and spot size, and can be coupled back to the waveguide. The ratio of the Gaussian beam width at the micromirror (Wₘ) to that at the waveguide (Wₒ) is given by:

$$\frac{{W}_{m}}{{W}_{o}} = \frac{{f}_{2}}{{f}_{1}} \qquad ( 1 )$$

where f₁ and f₂ are the focal lengths of the collimating lens and the focusing lens, respectively. The focused spot size on the MEMS micromirror can be adjusted by changing the focal length of the collimating lens alone.

Based on the channel spacing of 20 nm (CWDM) and the angular dispersion of 0.074°/nm, the focal length of the focusing reflector (f₂) is determined to be 15.5 mm for a micromirror pitch of 400 μm. A micromirror confinement factor of 2.75 was used to achieve flat passbands. The focal length of the collimating reflector (f₁) is 426 μm for the 5 μm wide waveguide, which is calculated according to the relation f₁/f₂=Wₒ/Wₘ, where Wₒ and Wₘ are the Gaussian beam widths at the waveguide and micromirror, respectively. The device footprint is reduced to 2×1 cm² by employing a 45° folding mirror. Detailed device parameters are summarized in Table 1.

Diffraction Loss of Air Gap

To accommodate the release area and metal coating of the micromirror, an air gap is needed between the slab region and the micromirror. However, without vertical confinement in the gap, the light diverges vertically during propagation and causes diffraction loss when reflected back to the slab region.

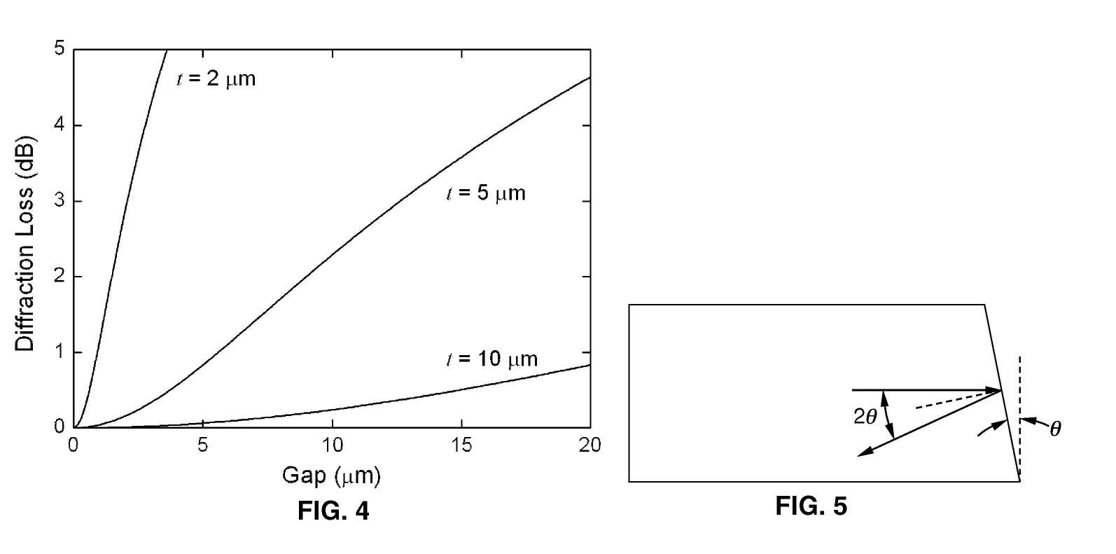

FIG. 4 illustrates simulated diffraction loss as a function of the gap for various slab thicknesses. The light is modeled as a Gaussian beam with a waist radius Wₒ of 1.9 μm for the 5 μm thick silicon slab waveguide. After propagation of a distance z, the beam width W(z) and wavefront radius of curvature R(z) are given by:

$$\begin{matrix}W ( z ) = {W}_{o} \sqrt{1 + {( \frac{z}{{z}_{o}} )}^{2}} & ( 2 ) \\ R ( z ) = z [ 1 + {( \frac{{z}_{o}}{z} )}^{2} ] & ( 3 )\end{matrix}$$

where zₒ is the Rayleigh range and is given by:

$${z}_{o} = \frac{π {W}_{o}^{2}}{λ} \qquad ( 4 )$$

The diffraction loss can be calculated by the overlap integral as:

$${η}_{diffraction} ( gap ) = \frac{{\vert {\int }_{- ∞}^{∞} exp ( - \frac{{x}^{2}}{{W}_{o}^{2}} ) \cdot exp ( - \frac{{x}^{2}}{{W ( 2 \cdot gap )}^{2}} - \frac{ⅈ {kx}^{2}}{2 R ( 2 \cdot gap )} ) ⅆ x \vert}^{2}}{{\int }_{- ∞}^{∞} exp ( - \frac{2 {x}^{2}}{{W}_{o}^{2}} ) ⅆ x \cdot {\int }_{- ∞}^{∞} exp ( - \frac{2 {x}^{2}}{{W ( 2 \cdot gap )}^{2}} ) ⅆ x} \qquad ( 5 )$$

A gap of 10 μm was chosen for ease of fabrication, which has a diffraction loss of 2.3 dB. It can be reduced by decreasing the gap spacing or increasing the slab thickness.

Anti-Reflection Coating

In addition to diffraction loss in the air gap, there is also Fresnel loss at the silicon-air interface for light transmission. The power reflectance R at the boundary between two dielectric media is given by:

$$R = {( \frac{1 - p}{1 + p} )}^{2} \qquad ( 6 )$$

where p=n₁/n₂ is the ratio of the refractive indices of the two media. A Fresnel loss of 1.6 dB occurs for each transmission at silicon-air interface. Therefore a single layer anti-reflection coating is fabricated for reduction of the loss. The reflection from the air-coating and coating-Si interfaces should have a phase shift of π/2 and equal intensity to cancel each other. For the reflectance to be the same at the two interfaces, it requires:

$$\begin{matrix}\frac{{n}_{1}}{{n}_{c}} = \frac{{n}_{c}}{{n}_{2}} & ( 7 ) \\ {n}_{c} = \sqrt{{n}_{1} \cdot {n}_{2}} & ( 8 )\end{matrix}$$

where n₁, n₂, and n_{c} are the refractive indices of the two media and the coating material, respectively. The π/2 phase shift can be achieved with a film thickness t of a quarter wavelength:

$$t = \frac{{λ}_{o}}{4 {n}_{c}} \qquad ( 9 )$$

The resultant reflectance for normal incidence is given by:

$$R = {( \frac{{n}_{1} {n}_{2} - {n}_{c}^{2}}{{n}_{1} {n}_{2} + {n}_{c}^{2}} )}^{2} \qquad ( 10 )$$

For the silicon-air interface (n₁=3.48, n₂=1) a refractive index of 1.87 is thus desired for the coating material. The LPCVD silicon nitride is commonly used in CMOS process and has a refractive index ranging from approximately 2 to 2.2, depending on the stoichiometry (Si-rich film has higher index). A lower refractive index is desired for minimum Fresnel loss; however, lower concentration of silicon also induces higher stress, which may lead to buckling of released MEMS structures. In a preferred embodiment we have chosen the use of low-stress silicon nitride with a refractive index of 2.15 for AR coating. The required thickness is 1802 Å, and the Fresnel loss is 0.09 dB/transmission.

Sidewall Angle Effect

FIG. 5 represents sidewall angle effect. In the monolithic 1×4 WSS, light is vertically confined in the slab region and reflected by the etched sidewalls of optical components such as gratings, parabolic reflectors, and folding reflectors. As shown in the figure, a sidewall angle of θ causes the reflected beam to propagate at an angle of 2θ, resulting in an optical loss because of the coupling to the waveguide with a tilting angle. The sidewall angle effect can be simulated using an overlap integral with a linear phase term representing the wavefront tilt:

$${η}_{sidewall} ( θ ) = \frac{{\vert {\int }_{- ∞}^{∞} exp ( - \frac{{x}^{2}}{{W}_{o}^{2}} ) \cdot exp ( - \frac{{x}^{2}}{{W}_{o}^{2}} - ⅈ kx tan ( 2 θ ) ) ⅆ x \vert}^{2}}{{\int }_{- ∞}^{∞} exp ( - \frac{2 {x}^{2}}{{W}_{o}^{2}} ) ⅆ x \cdot {\int }_{- ∞}^{∞} exp ( - \frac{2 {x}^{2}}{{W}_{o}^{2}} ) ⅆ x} \qquad ( 11 )$$

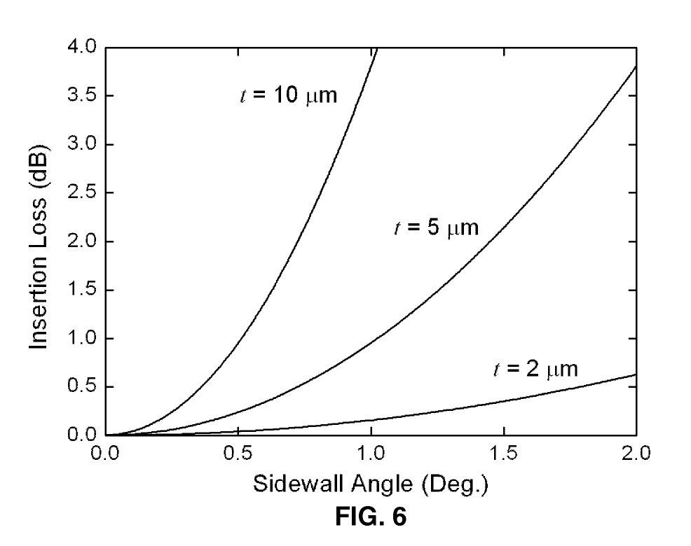

FIG. 6 illustrates simulated insertion loss for slab thickness of 2, 5, and 10 μm. Smaller slab thickness reduces sidewall angle effect, however, it leads to higher diffraction loss because of the larger divergence angle. The sidewall angle for a slab thickness of 5 μm should be less than 0.33° to achieve an insertion loss of <0.1 dB/TIR.

Free Carrier Absorption

The propagation loss in SOI waveguides mainly arises in response to scattering and absorption. The scattering loss is due to the roughness at the optical interfaces and can be reduced with appropriate fabrication techniques, while the absorption loss is a result of interband absorption and free carrier absorption. The former was reported as 0.004 dB/cm at λₒ=1.52 μm, while the latter can be evaluated by the Drude-Lorenz model:

$$Δ α = \frac{{ⅇ}^{3} {λ}_{o}^{2}}{4 {π}^{2} {c}^{3} {ɛ}_{o} n} ( \frac{Δ {N}_{e}}{{{μ}_{e} ( {m}_{ce}^{*} )}^{2}} + \frac{Δ {N}_{h}}{{{μ}_{h} ( {m}_{ch}^{*} )}^{2}} ) \qquad ( 12 )$$

where e is the electronic charge, c is the velocity of light in vacuum, μₑ is the electron mobility, μₕ is the hole mobility, m*_{ce} is the effective mass of electrons, m*_{ch} is the effective mass of holes, ΔNₑ is the free electron concentration, ΔNₕ is the free hole concentration, εₒ is the permittivity of free space, and λₒ is the free space wavelength. The value for Δα has been experimentally determined producing the empirical expression for silicon at λₒ=1.55 μm as:
Δα=8.5×10⁻¹⁸·ΔNₑ+6.0×10⁻¹⁸·ΔNₕ (13)

Table 2 lists calculated free carrier absorption loss for various carrier concentration with n-type dopant. The CWDM 1×4 WSS has a propagation distance of approximately 6.5 cm for this embodiment, which requires the resistivity of the device layer to be higher than about 10 Ω-cm to achieve propagation loss less than 0.1 dB.

Device Fabrication

Fabrication Flow Example

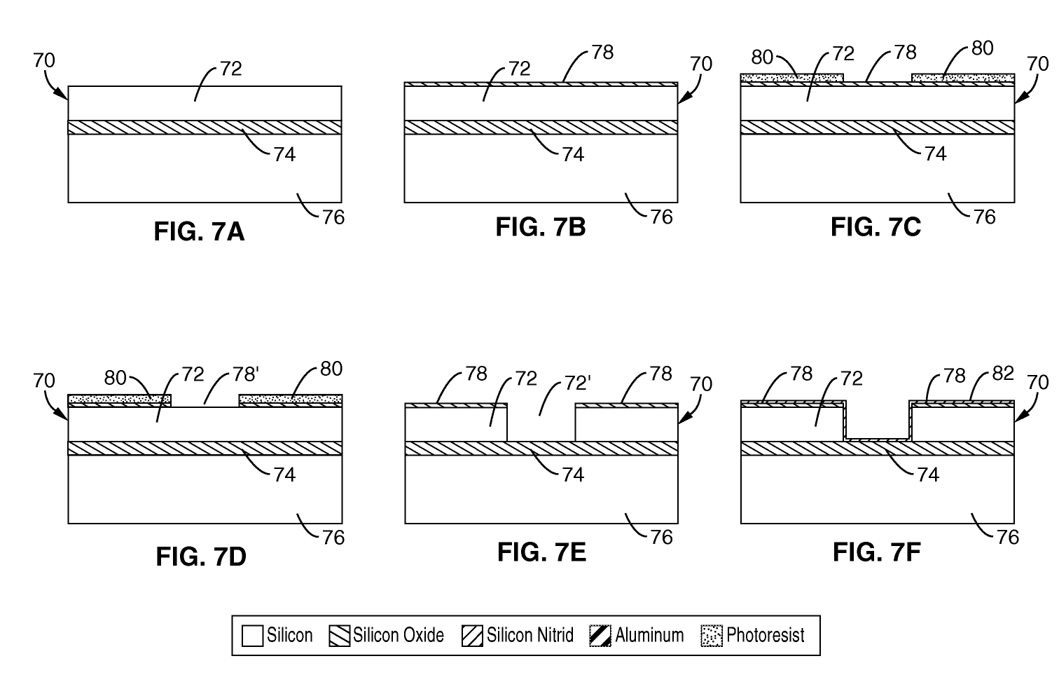

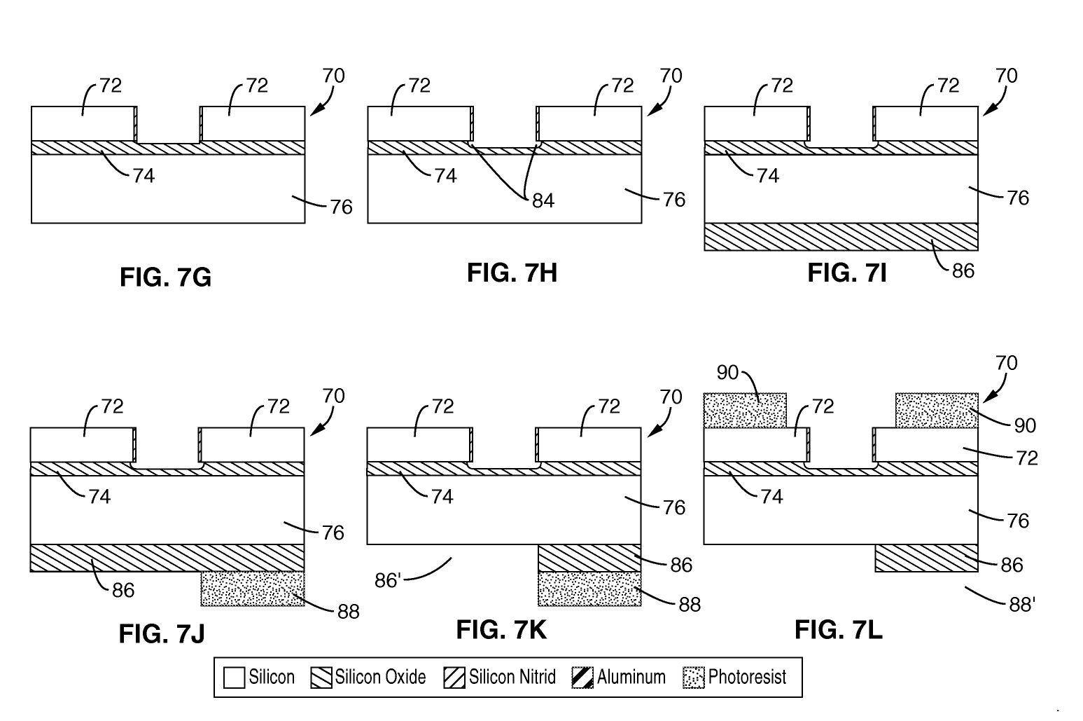

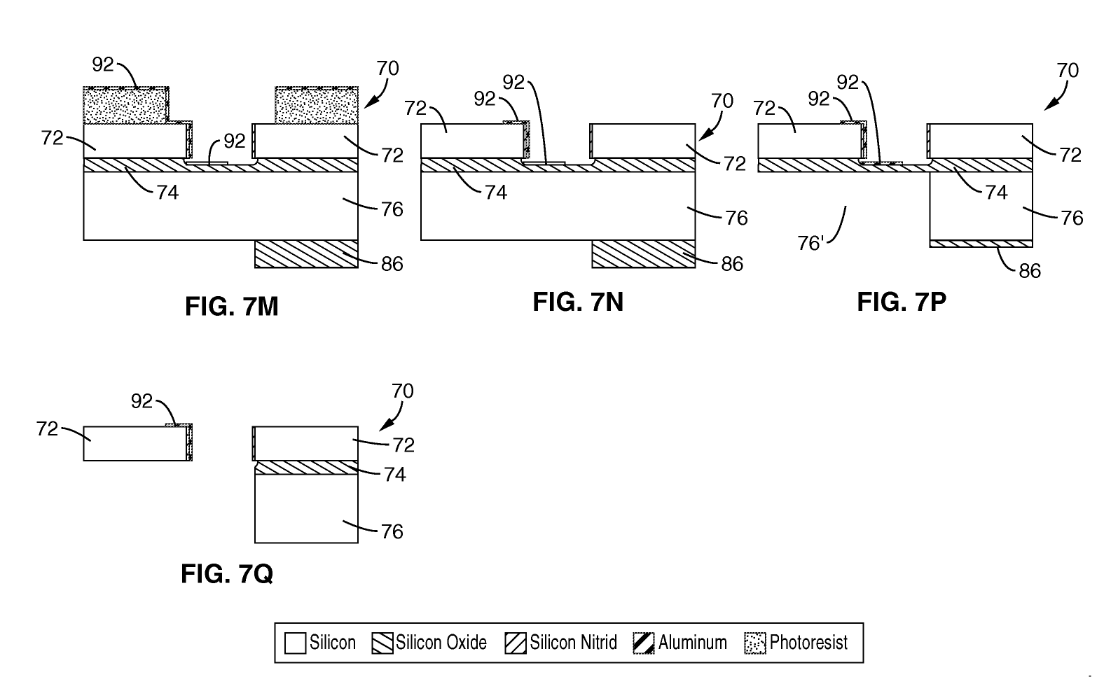

FIG. 7A-7Q illustrates a fabrication process for an exemplary device on a silicon-on-insulator (SOI) wafer 70 shown in FIG. 7A having a device layer 72, such as a 5 μm thickness, a buried silicon dioxide (SiO₂) layer 74 such as 2 μm thickness, and a base portion 76. In FIG. 7B a layer of thermal oxide 78 (e.g., 5000 Å) was grown as the hard mask for silicon etching. The waveguides, parabolic mirrors, gratings, and MEMS micromirrors were all patterned 80 with i-line optical lithography as shown in FIG. 7C.

By way of example and not limitation, the oxide and silicon were etched with the Applied Materials™ Precision 5000™ etcher, which is a cluster tool consisting of four etching chambers surrounding a central loadlock. In this example, oxide 78′ was etched using fluorine (CHF₃) based chemistry at an etch rate of 2000 Å/min as in FIG. 7D. After stripping the photoresist, a portion 72′ of the 5 μm thick silicon device layer was removed as shown in FIG. 7E. Silicon was removed, for example, by etching such as according to a magnetically-enhanced reactive-ion etch (MERIE) using HBr and NF₃, resulting in an etch rate for this example of around 1 μm /min. The resulting peak-to-peak sidewall roughness for this process was 20-30 nm. To remove the oxide-like by-product from HBr etching process, the sample was dipped in the 50:1 HF for 60 seconds.

A conformal layer of silicon nitride 82 (1800 Å) was deposited by low-pressure chemical vapor deposition (LPCVD) as an anti-reflection coating on the sidewall in FIG. 7F. A blank dry etching process removed the silicon nitride on the top surface for the later metal deposition of the probing pads in FIG. 7G. An undercut 84 underneath the micromirror was created by an HF dip for a lift-off process performed later in FIG. 7H. To reduce the thermal stress of metal on the micromirror, the backside patterning was performed before metallization.

A layer of oxide 86 (e.g., 4 μm ) was deposited, such as by plasma enhanced chemical vapor deposition (PECVD) as the hard mask for backside silicon etching as seen in FIG. 7I, patterned with a photoresist 88 (e.g., 5 μm thick) as seen in FIG. 7J, and etched to remove a portion 78′ of the buried SiO₂ layer by a plasma oxide etching as in FIG. 7K. After the photolithography for metallization is performed resulting in FIG. 7L, metallization (e.g., aluminum) 90 was deposited on the front sidewall of MEMS micromirrors, such as by e-beam evaporation with a 30° tilting angle with the result seen in FIG. 7M.

The probe contact area 92 was deposited and was patterned by the lift-off process after evaporation with the result seen in FIG. 7N. The backside of MEMS micromirrors was etched by a deep reactive ion etching (DRIE) using the Bosch process, which consists of cycled etching and passivation steps yielding the structure shown FIG. 7P. The resulting etch rate of the Bosch process is approximately 3 μm/min. Plasma etching was used to remove the buried oxide for dry-releasing. The chips were self-separated after the releasing step, eliminating the need for cleaving or dicing with the resultant structure depicted in FIG. 7Q.

Optimization of Silicon Etching

As discussed in the previous section on “Sidewall Angle Effect”, the etched sidewall angle of the 5 μm device layer should be within 90±0.3° to provide an insertion loss less than approximately 0.1 dB/TIR. To achieve the straight sidewall, an inhibiting layer is needed for protection during etching. This inhibiting layer provided by any of a number of methods, including one of the following four methods, or combinations:
(a) adding gases to form polymers;
(b) redepositing the reaction byproduct of etching;
(c) adding O₂ to form silicon oxides; or
(d) eroding and redepositing mask materials.

The standard Bosch process belongs to category (a), which utilizes cycled etching and passivation steps to achieve vertical sidewalls. However, the intermittent etching process causes the “scalloping effect”, which refers to a periodic sidewall roughness. This is not desirable for optical applications since it degrades optical performance.

The HBr/NF₃ process is in category (b), and both gases etch silicon but only HBr forms the inhibiting layer. The verticality of the etch is achieved with a balanced etching and deposition rate of the inhibiting layer. The sidewall has a negative slope when the etching rate exceeds the deposition rate, and vice versa. In comparison with HBr, NF₃ has a smaller selectivity to oxide. It adds an additional degree of freedom for fine tuning the slope of the sidewalls.

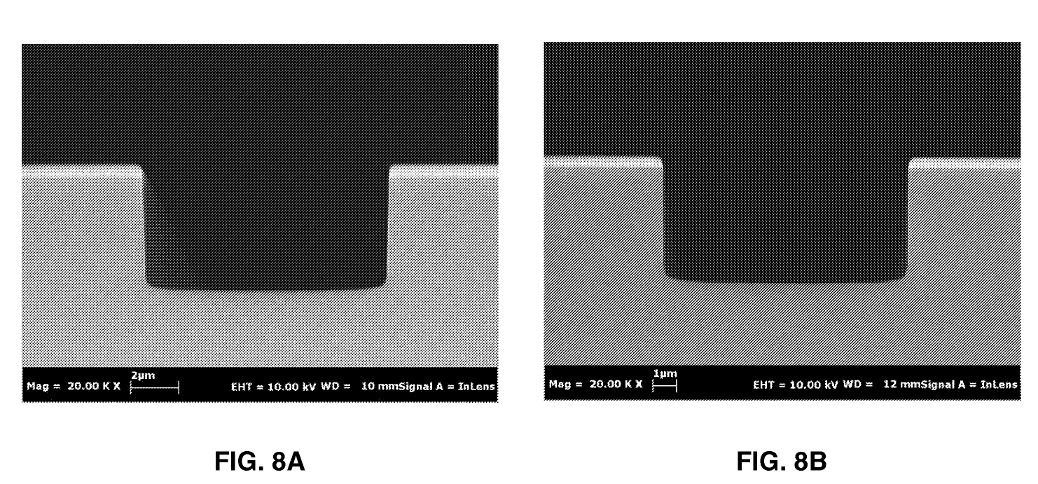

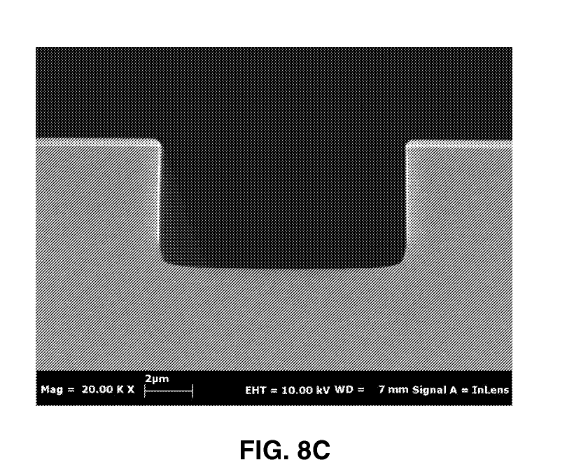

FIG. 8A-8C illustrates a transition from positive to negative slopes being observed in response to an increasing gas flow of NF₃, while other etching conditions remain fixed. In addition to the gas flow, the total exposed area and the width of trenches also influence the sidewall profile because the amount of reaction byproducts is proportional to the etching area. Therefore, the total exposed area was controlled to less than 20%, and the trench exhibits a uniform width of 10 μm except for the triangular grating elements, which are restricted by the grating shape and period.

Hydrogen Annealing

The etching of silicon is usually accompanied by sidewall roughness which results from various micromasks, such as dust, redeposition of mask material, etching byproduct, and so forth. The roughness of high-index-contrast materials may cause severe scattering loss for light propagation, reflection, or transmission. The roughness can be removed by hydrogen annealing. The surface mobility of silicon atoms is enhanced by the use of heated hydrogen at temperatures lower than the melting point (1414° C.) of silicon. The migration of atoms smoothes out the surface roughness to minimize the total surface energy without losing volume.

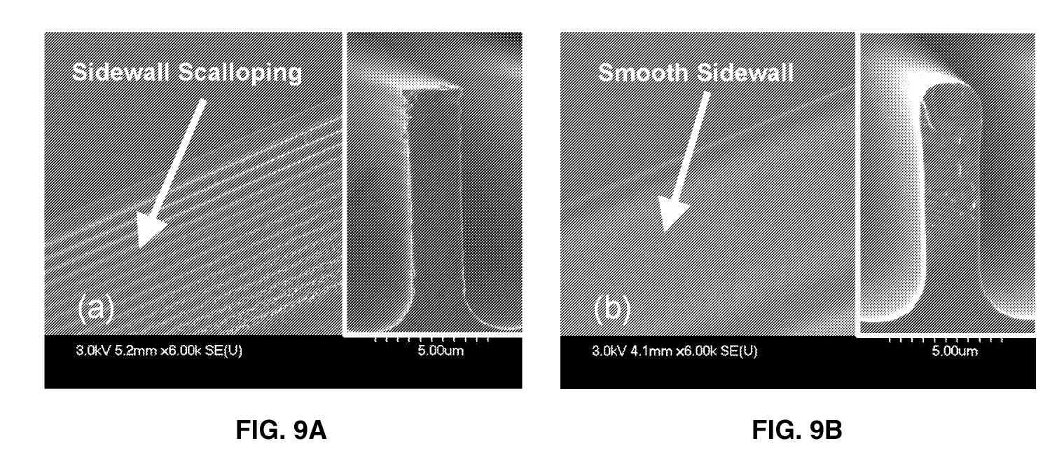

FIG. 9A-9B compares images showing sidewall roughness before and after hydrogen annealing at 1100° C. and 10 Torr for 10 minutes. It will be appreciated that the surface roughness can be reduced to a root-mean-square roughness of 0.26 nm using this technique. In addition, to the removal of sidewall roughness, hydrogen annealing also results in rounded profiles and geometric shapes.

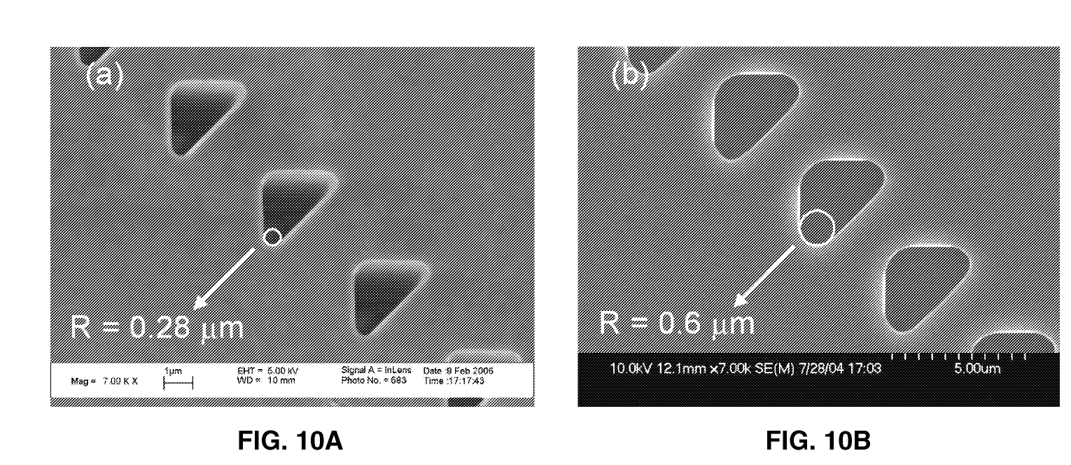

FIG. 10A-10B compares the shape of the triangular grating element before and after hydrogen annealing at 1000° C. and 1 atm for 10 minutes. The corner radius increases from 0.28 μm to 0.6 μm, which leads to higher grating loss. Therefore, a trade-off is made in determining the time period over which hydrogen annealing should be performed. Preferably the annealing process time is selected to optimize the trade-off between reducing scattering loss and increasing grating loss.

Angled Evaporation

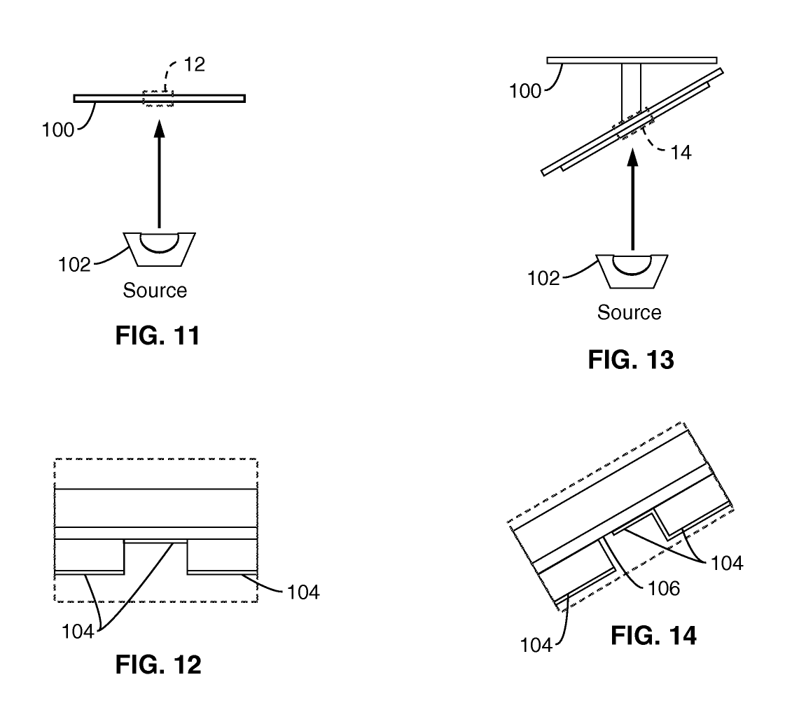

FIG. 11-12 illustrates a mirror coating process using standard evaporation. To enhance the reflectivity of the micromirror, a thin layer of a reflective material, preferably metal, is coated on the front sidewall of micromirror 100 from a coating source 102 in FIG. 11. Coating 104 can be seen in the inset of FIG. 12 as being evenly distributed on the flat surfaces and partially covering the sidewalls of the trench. Typical thin film deposition techniques used in semiconductor manufacturing include filament evaporation (or thermal evaporation), e-beam evaporation, sputtering, and chemical vapor deposition (CVD). It should be appreciated that evaporation has well-controlled directionality, which is well-suited for use with the lift-off process, yet it exhibits poor sidewall coverage. Sputtering and CVD process provide beneficial step-coverage, however, these processes cover all sidewalls, which is not generally desirable in this case as metal should not cover the opposite sidewall of the air gap to prevent light transmission.

FIG. 13-14 illustrates the coating process utilizing an angled evaporation process. For the metal to be coated on one sidewall only, the evaporation process is modified by tilting the sample, such as with an angle of 30° as shown in FIG. 13. The inset of FIG. 14 shows a resultant coating 104 which covers one sidewall and leaves a gap 106 (uncovered) on the other sidewall. FIG. 11-14 provide a comparison between the standard and modified evaporation process. By mounting the sample on a tilted fixture, only one sidewall is coated with metal, while the other sidewall remains clear. Using this technique, the metal can still be patterned using a lift-off process.

Fabricated Devices

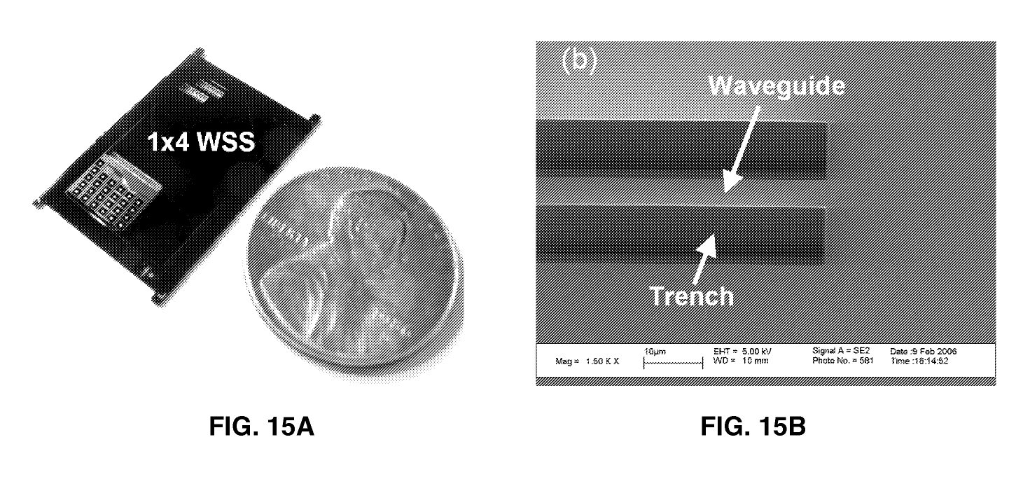

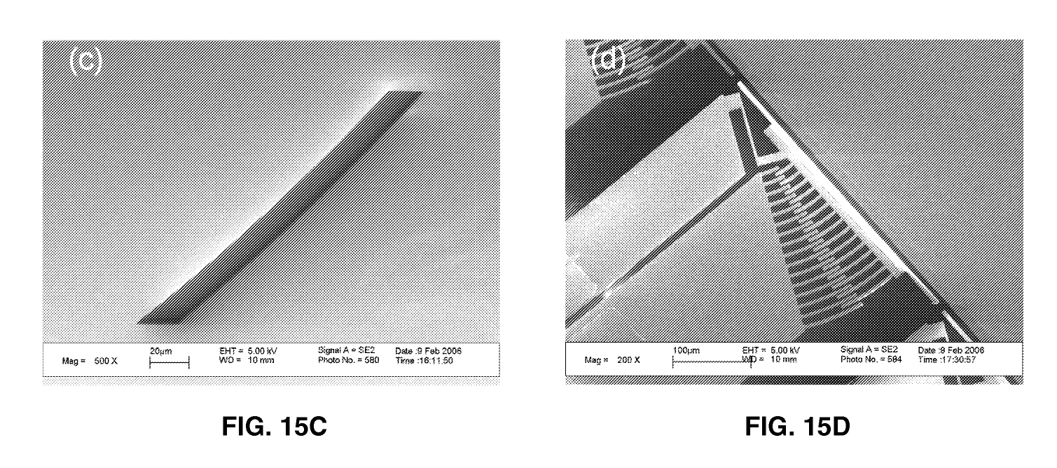

FIG. 15A-15D depicts photographs and SEM images of the fabricated WSS device. The monolithic 1×4 WSS has a chip area of 2×1.4 cm². In this example, the 5 μm wide waveguide is sandwiched between two 10 μm wide trenches for optimized sidewall profile. The collimating reflector is also etched with a trench width of 10 μm. The micromirror array has a mirror pitch of 400 μm and a fill factor of 97.5%.

Experimental Results

Experimental Setup

The 1×4 WSS was tested using a 12-channel lensed fiber array to couple to the input and the output ports. The lensed fiber array is specified with a spot size of 5 μm and a fiber pitch of 250 μm, matching the dimension and spacing of the waveguides. The fiber array is mounted on a 5-axis stage for precise alignment to the device. To ensure efficient coupling for all the waveguides, the device and fiber array must lie in the same horizontal plane. This can be achieved by optimizing the coupling of two alignment waveguides on two ends. An infrared camera is used to monitor the output intensity during alignment.

Optical Measurement of the 1×4 Wavelength-Selective Switches

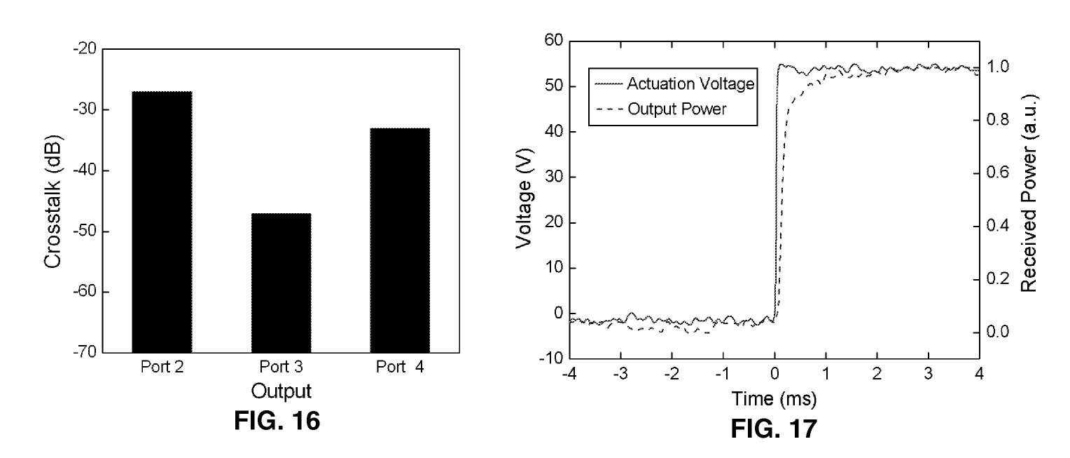

FIG. 16 through FIG. 19B illustrate optical measurements of crosstalk, switching time, and response for the 1×4 WSS represented in FIG. 1. The optical loss was measured on a static device with fixed micromirror. Port 1 (port 16a in FIG. 1) was the input and ports 2 to 5 (ports 16b-16e in FIG. 1) were the outputs. With micromirrors fixed at zero degrees, the reflected light was coupled to port 5 (16e in FIG. 1), which was at the symmetric position.

The fiber-to-fiber insertion loss was measured at 11.7 dB, and the crosstalk was measured at less than −27 dB as shown in FIG. 16. FIG. 17 shows the temporal response for switching from port 1 (16a of FIG. 1) to port 4 (16d of FIG. 1) by applying a square wave. The received power was measured by a photo detector. The measured switching time (10% to 90%) was around 0.5 msec. A pseudo-random digital pattern generator is used to test the transmission of digital signals through the WSS.

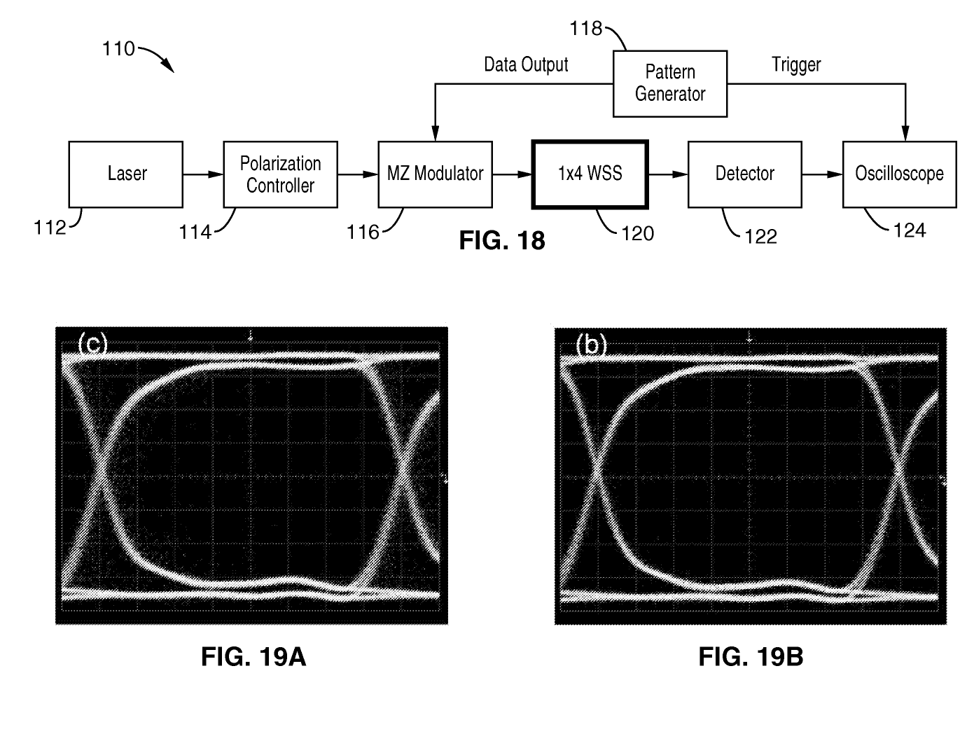

FIG. 18 illustrates the experimental setup 110 with laser 112 through a polarization controller 114 into modulator 116 which receives a modulation signal from pattern generator 118. The modulated signal from modulator 116 is received by 1×4 WSS 120 whose output is registered by detector 122 and registered on oscilloscope 124. In this specific test setup, pattern generator 118 outputs a 2.5 Gb/s data stream sent to a Mach-Zehnder (MZ) modulator. The modulated optical signal is routed through the WSS and then the signal is detected and sent to the vertical input of the oscilloscope for recording.

FIG. 19A-19B are oscilloscope patterns generally referred to as “eye diagrams”. Output is shown without the 1×4 WSS in FIG. 19A, and with the 1×4 WSS in FIG. 19B. It should be appreciated that the wide open eyes in these traces indicate that the signals are not significantly degraded by the insertion of the WSS.

Breakdown of Insertion Loss

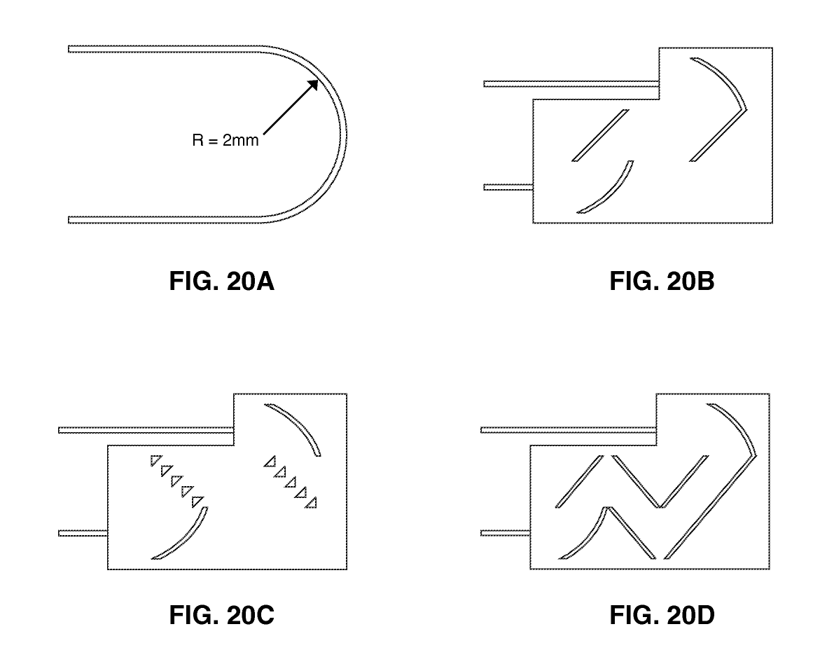

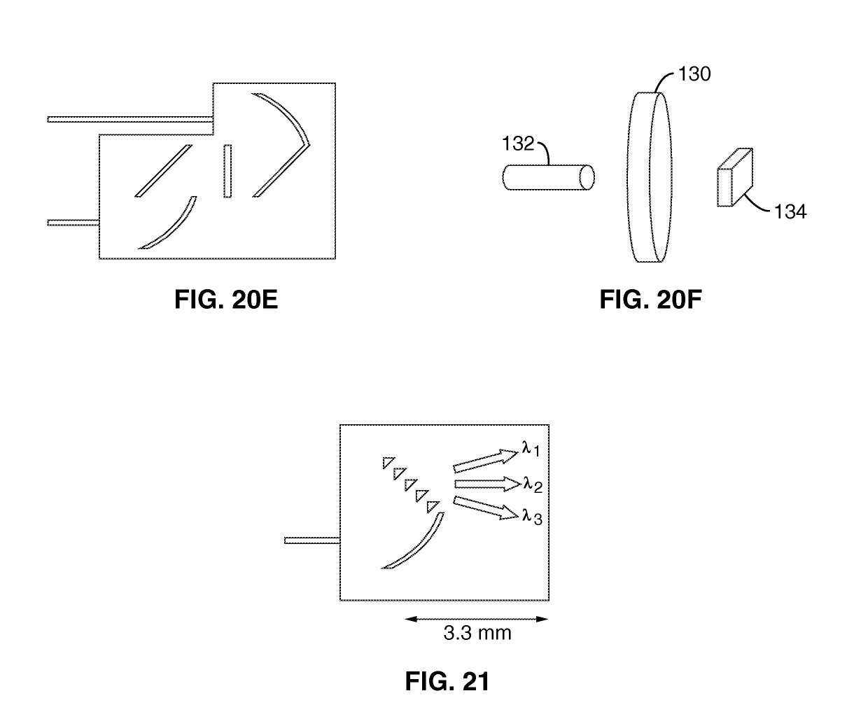

FIG. 20A-20F illustrate test structures utilized to gain more insight into the source of optical insertion loss and to characterize each integrated optical component. Table 3 shows the breakdown of measured and simulated insertion loss. The former was obtained from the measurement of test structures fabricated on the same wafer.

A coupling loss of 2.3 dB was measured for a looped-around waveguide, as shown in FIG. 20A. The bending loss was negligible for a large bending radius of 2 mm. The measured loss was higher than the calculated value, the excess loss appears to be attributable to optical misalignment and imperfections in waveguides and lensed fibers. Fundamentally, the coupling loss can be reduced to 0.2 dB using an optimized lensed fiber with a matched spot size of 3.8 μm to the 5×5 μm² waveguides.

The structure in 20B comprises two collimating parabolic reflectors and two folding reflectors. The parabolic reflectors are located at the focal length of 426 μm from the input/output waveguides, and a distance of 125 μm from the folding reflectors. All reflectors are considered to have the same dimension of 125×125 μm² in this example, with the distance between the two folding reflectors being 600 μm. This structure is used as a reference for the following measurement.

The grating loss was measured by replacing the two folding reflectors with two sets of microgratings with a period of 4.455 μm (m=14), as shown in FIG. 20C. The measured grating loss (6 dB) was higher than the theoretical value of 2 dB because of the corner rounding of the triangular element and the imperfect sidewall profile inside the small trenches. It can be reduced with a larger grating period that corresponds to higher grating order, at the expense of smaller free spectral range, which limits the operating bandwidth. Table 4 shows the measured insertion losses for grating periods from 2.025 μm (m=9) to 9.9 μm (m=44). The results agree well with simulation based on a rounded corner, in which the sharp corner is drawn as an arc with a radius of 5.5 μm. The grating loss can be further reduced by using a reflection grating, which can be fabricated with wider trenches.

The test structure in FIG. 20D was used to characterize the sidewall angle effect on reflection loss. It has a total of eight reflections, all of which are separated by a distance of 125 μm. The measured loss of 0.06 dB/TIR corresponds to a sidewall angle of 0.30.

The diffraction loss was measured with the structure shown in FIG. 20E. A 20 μm wide air gap was inserted between the two folding reflectors. The diffraction loss was equivalent to a round trip through the 10 μm wide air gap. The measured loss of 2.8 dB is close to the theoretical 2.3 dB. It can be reduced to 0.8 dB by shrinking the gap spacing to 5 μm.

The Fresnel loss was measured with a free-space setup as shown in FIG. 20F. A double polished silicon wafer 130 was coated with low stress nitride, and inserted between a collimator 132 and a large area photo detector 134. The measured loss was 0.1 dB/interface, which agrees well with the simulation result. It can be further reduced by an alternative AR coating material with the refractive index better matched to the ideal value of 1.87.

Characterization of Micrograting

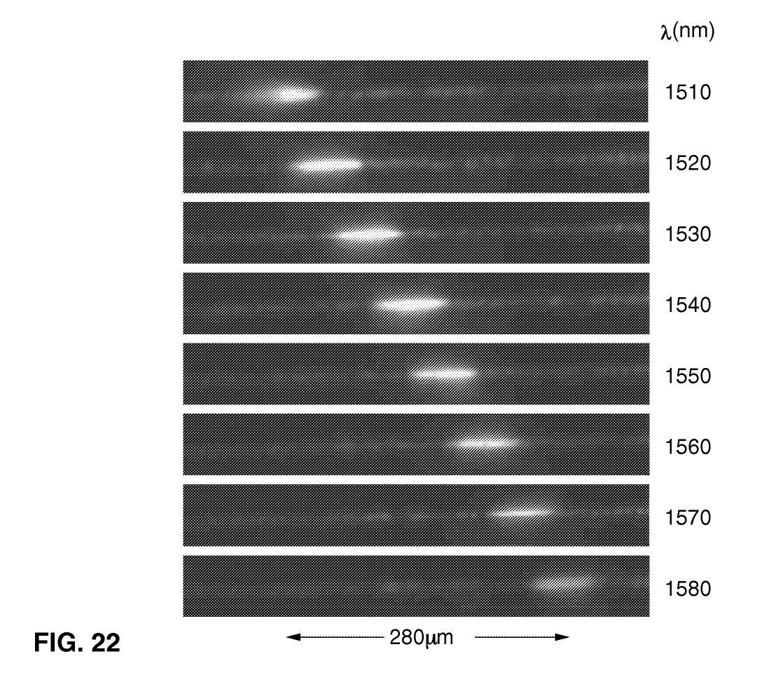

FIG. 21 and FIG. 22 illustrate a beam splitting embodiment and an output result image sequence, respectively. The reflector and micrograting are shown in FIG. 21 dispersing a beam into multiple wavelengths. The angular dispersion of the micrograting was measured by recording the beam position while the input wavelength was tuned from 1510 nm to 1580 nm. An infrared camera was used to observe the near field images at the cleaved facet of the chip as seen in FIG. 22. The angular dispersion (Δθ/Δλ) of 0.069°/nm was calculated from the measured linear dispersion (Δx/Δλ) and the distance between the micrograting and the edge of the chip. The 7% discrepancy with the predicted value 0.074°/nm was likely due to the inaccuracy of the position reading from the images.

Silicon-Based Monolithic N×N WSXC

Architecture of 4×4 Wavelength-Selective Cross Connects

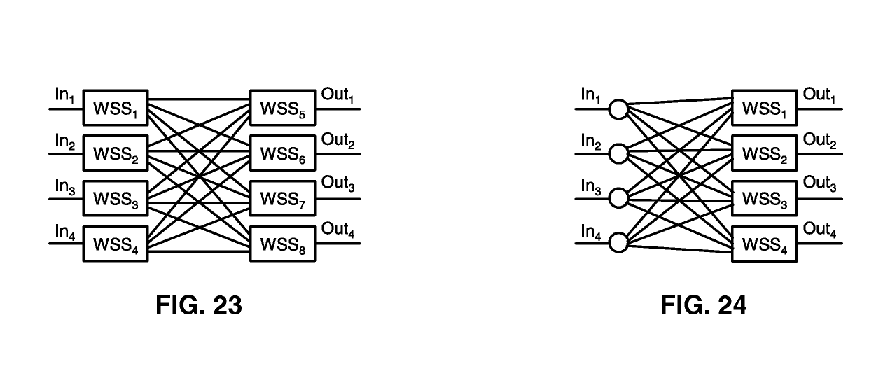

FIG. 23 and FIG. 24 illustrate example WSXC cross connects using the WSS embodiments shown. A 4×4 WSXC can be realized by using 1×4 WSSs as building elements within a given architecture. For example, the WSXC can be made by cascading either four 4×1 WSSs with four 4×1 WSSs as in FIG. 23, or four passive 1×4 splitters with four 4×1 WSSs as seen in FIG. 24. The latter has a fundamental splitting loss of 6 dB but it allows broadcast and multicast functions and has a smaller chip area (approximately 60% of the 8-WSS approach) which also makes it attractive for monolithic integration.

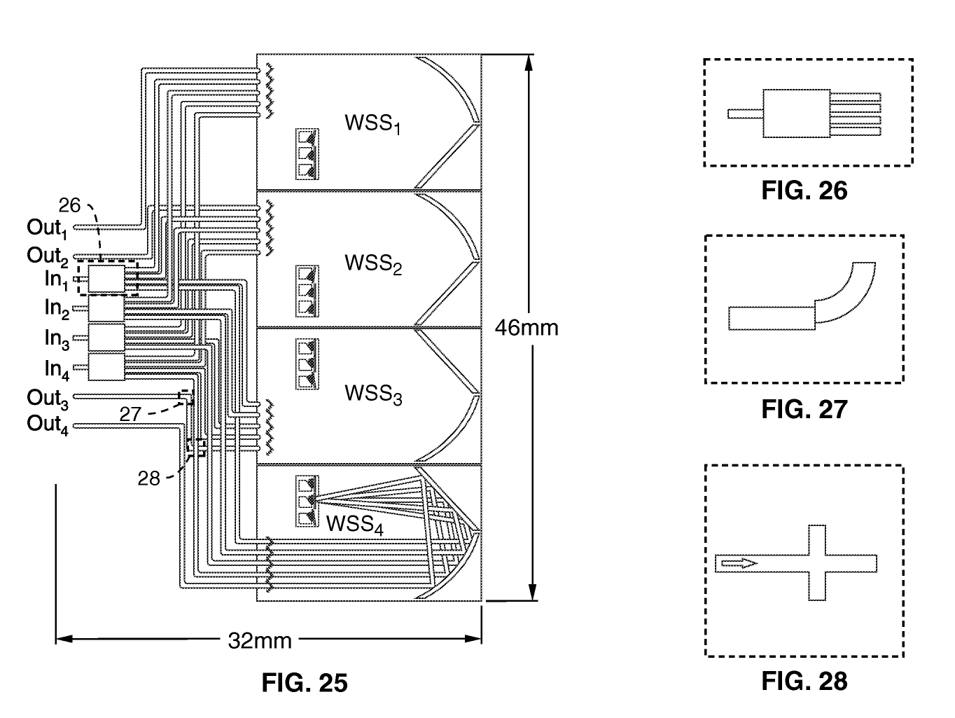

FIG. 25 through FIG. 28 illustrate a schematic of an exemplary embodiment of a monolithic 4×4 WSXC. Four 4×1 WSSs and four 1×4 splitters are interconnected on the same SOI wafer. No fiber connections or external splitter are required. The 4×1 WSS, such as shown in FIG. 1, comprises 5×5 μm² waveguides, collimating reflectors, microgratings, a focusing reflector, a folding reflector, and a micromirror array matching to the CWDM (1470-1610 nm) grids with 20 nm spacing. The input signals are broadcast to each WSS by the 1×4 multimode interference (MMI) coupler. In each WSS, port 1 is used as output and port 2 to 5 as inputs. By scanning the micromirror, the signal can be selected from one of the inputs and switched to the output. The 1×4 splitters and the 4×1 WSSs are connected by waveguides with a 90° waveguide bend and 90° waveguide crossing, which minimize insertion loss and crosstalk. The two lower WSSs are flipped vertically to reduce the number of waveguide crossings such that there are no more than ten crossing in any configuration.

1×4 Multimode Interference Couplers

The 4×4 architecture shown in FIG. 24 requires 1×4 power splitters for the broadcast function. The 1×4 power splitter can be realized by using cascaded Y junctions, MMI splitters, or star couplers known in the art. It will be appreciated that MMI splitters have less polarization sensitivity and more relaxed fabrication requirements compared to other techniques.

The principle of operation of interference couplers is based on self-imaging of the input field such that an array of identical images is formed at the location of output waveguides.

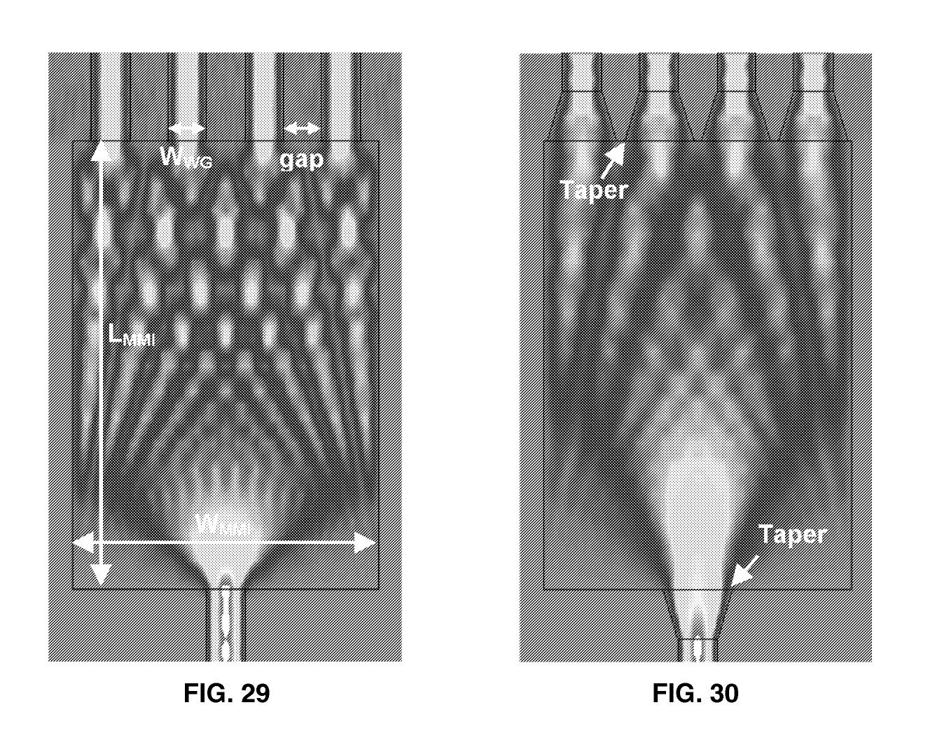

FIG. 29 depicts the beam propagation method (BPM) simulation of a conventional 1×4 MMI splitter. The width of the slab region (W_{MMI}) is determined by the waveguide width (W_{WG}) and the gap g between waveguides:
W_{MMI}=4(W_{WG}+g) (14)

The effective width (Wₑ) of the slab region is given by:

$${W}_{e} = {W}_{MMI} + \frac{{λ}_{o}}{π} {( \frac{{n}_{2}}{{n}_{1}} )}^{2 σ} \frac{1}{\sqrt{{n}_{1}^{2} - {n}_{2}^{2}}} \qquad ( 15 )$$

where σ=0 for transverse electric (TE) polarization and σ=1 for transverse magnetic (TM) polarization, n₁=3.48 and n₂=1 are the refractive indices of silicon and air, respectively. The propagation constant of the m^{th} order mode is given by:

$${β}_{m} \approx {n}_{1} {k}_{o} - \frac{{( m + 1 )}^{2} {π}^{2}}{2 {n}_{1} {k}_{o} {W}_{e}^{2}} = {β}_{o} - \frac{m ( m + 2 ) π}{3 {L}_{π}} \qquad ( 16 )$$

where L_{π} is defined as the beat length between the two lowest order modes:

$${L}_{π} = \frac{π}{{β}_{0} - {β}_{1}} \approx \frac{4 {n}_{1} {W}_{e}^{2}}{3 {λ}_{o}} \qquad ( 17 )$$

For the symmetric configuration shown in FIG. 29, only even modes of the slab region are excited. Therefore a single image of the input field is formed at a distance of:

$$L = \frac{π}{{β}_{0} - {β}_{2}} = \frac{{n}_{1} {W}_{e}^{2}}{{λ}_{o}} \qquad ( 18 )$$

while N identical images are formed at a distance of:

$${L}_{MMI} = \frac{L}{N} = \frac{{n}_{1} {W}_{e}^{2}}{N {λ}_{o}} \qquad ( 19 )$$

For a 1×4 MMI splitter with a W_{WG} of 5 μm and a gap of 5 μm, a W_{MMI} of 40 μm and a L_{MMI} of 899 μm are calculated from the analytical model. The optical performance was simulated by the BPM method with a splitting loss of 6.03 dB, a nonuniformity of <0.001 dB, and a polarization dependent loss of 0.03 dB.

The sensitivity of an MMI splitter to the fabrication tolerance can be evaluated from Eq. 19. It should be appreciated that a larger fabricated W_{MMI} corresponds to a longer L_{MMI}.

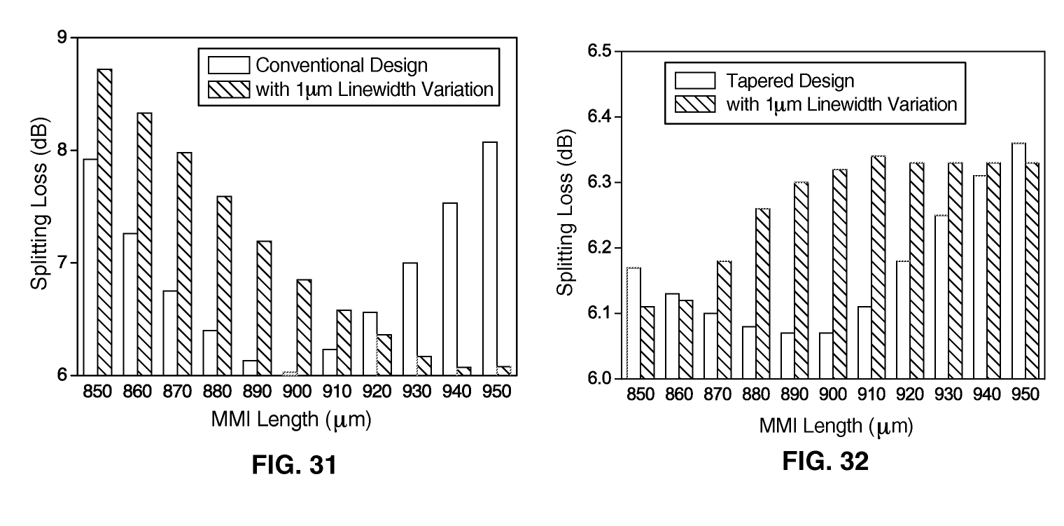

FIG. 31 compares the BPM simulated splitting loss of the MMI with a W_{MMI} of 40 μm and 41 μm. The variation of W_{MMI} increases the insertion loss to 6.86 dB at the designed L_{MMI} of 899 μm.

FIG. 30 illustrates an MMI splitter embodiment, shown according to a beam propagation method (BPM) simulation, which is less sensitive to linewidth variation. The input and output waveguides are tapered from 5 μm to 9 μm in a taper length of 100 μm .

FIG. 32 depicts the BPM simulated splitting loss for the splitter of FIG. 30. The loss was less than 6.4 dB for L_{MMI} ranging from 850 to 950 μm. This tapered design relaxes the fabrication requirement for the linewidth control.

Bent Waveguides

Bent (curved) waveguides are widely used in planar lightwave circuits (PLC) for the change of optical-path direction, such as Y junctions, Mach-Zehnder interferometers, and arrayed-waveguide gratings (AWG). Propagation in a bent waveguide involves radiation losses and transition losses. The radiation loss increases with a decreased bending radius; thus, a minimum radius should be determined for practical applications. The transition loss is due to mode mismatch between straight and bent waveguides.

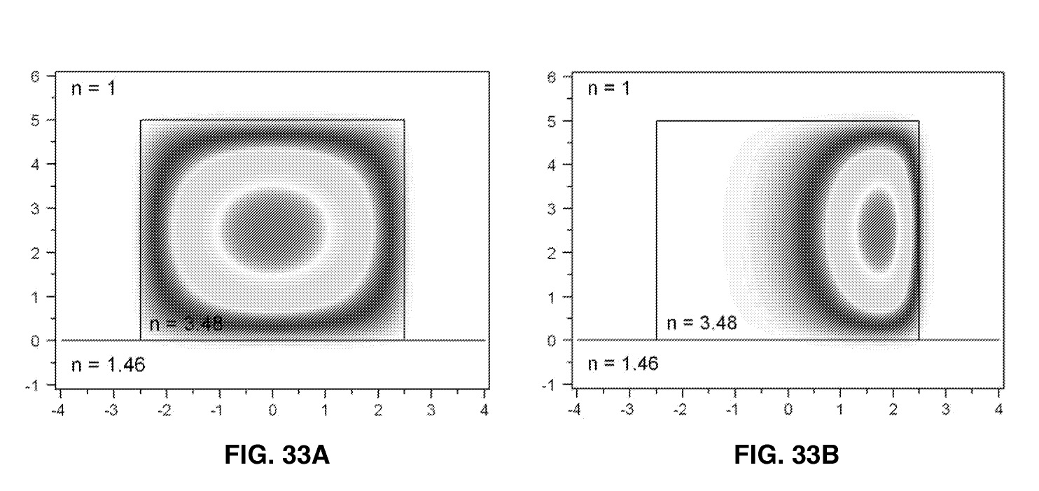

FIG. 33A and FIG. 33B illustrate simulated mode profiles for straight and bent waveguides. It should be recognized that the regular BPM method is limited to small propagation angles because of paraxial approximation. The bent waveguide can be simulated by the BPM method using conformal transformation to map the bent waveguide onto a straight waveguide. FIG. 33A shows the simulated mode profile of a straight SOI waveguide, while FIG. 33B shows the simulated mode profile for a bent SOI waveguide (R=100 μm in both cases). The bent SOI waveguide exhibits a mode position shift toward the outside of the arc. Due to strong confinement of SOI channel waveguides, the radiation loss can be ignored.

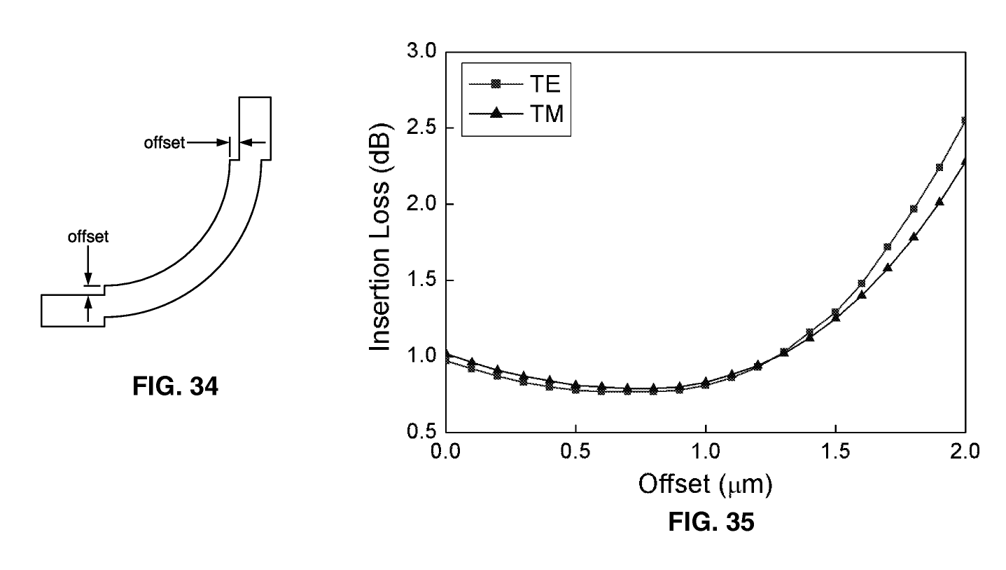

FIG. 34-35 illustrates bend transitions between straight and bent waveguides, including an offset, and associated transition loss curves. In FIG. 34 the offset amount is shown at both ends of the bend transitioning to the straight sections. In FIG. 35 loss results are shown for both optical polarizations (TE and TM), wherein it can be seen that the loss is dominated by transition loss which can be reduced with an optimized offset between the straight and bent waveguides. From the simulation graph for this implementation, it can be seen that the most efficient coupling for R=100 μm occurs at an offset of 0.7 μm. The loss can be further reduced utilizing a larger bending radius, in which mode matching is improved between the straight and bent waveguides, however, the use of a larger bending radius inevitably results in larger device dimensions.

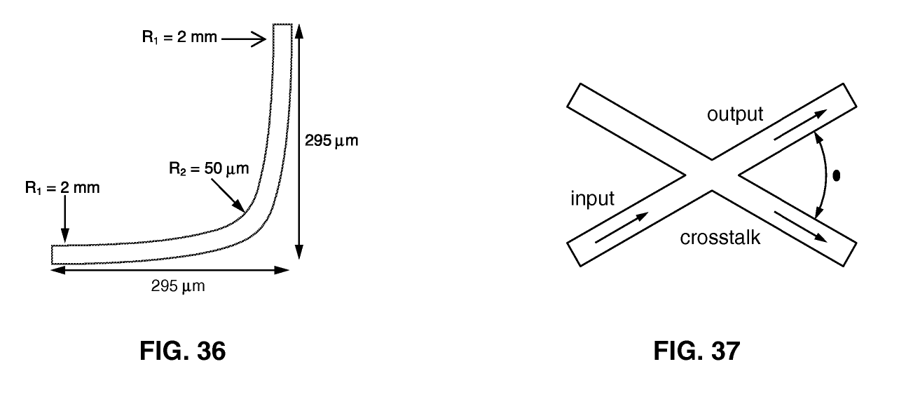

FIG. 36 illustrates a waveguide having an adiabatic bend radius to reduce transition loss. Adiabatic waveguide bending involves an adiabatic change of the bending radius to avoid excitation of higher-order modes. The initial radius should be sufficiently large for the transition from a straight waveguide, while the smallest radius should correspond to a negligible radiation loss. The adiabatic bending is beneficial with respect to its comparably small loss for the amount of bending and its significant reduction in dimensions. In FIG. 36 the example of 90° adiabatic bending has a radius which changes from R₁=2 mm at the bend-straight junctions to a minimum of R₂=50 μm as a function of bending angle θ.

$$R ( θ ) = ( {R}_{2} - 1 ) + exp ( \frac{ln ( {R}_{1} - {R}_{2} + 1 )}{\frac{π}{4}} \cdot \vert θ - \frac{π}{4} \vert ) \qquad ( 20 )$$

The resultant dimension is 295×295 μm², which is approximately forty-six (46) times smaller than the bending with a radius of 2 mm. A faster change of the radius leads to a further reduced dimension, but may induce higher loss.

Waveguide Crossings

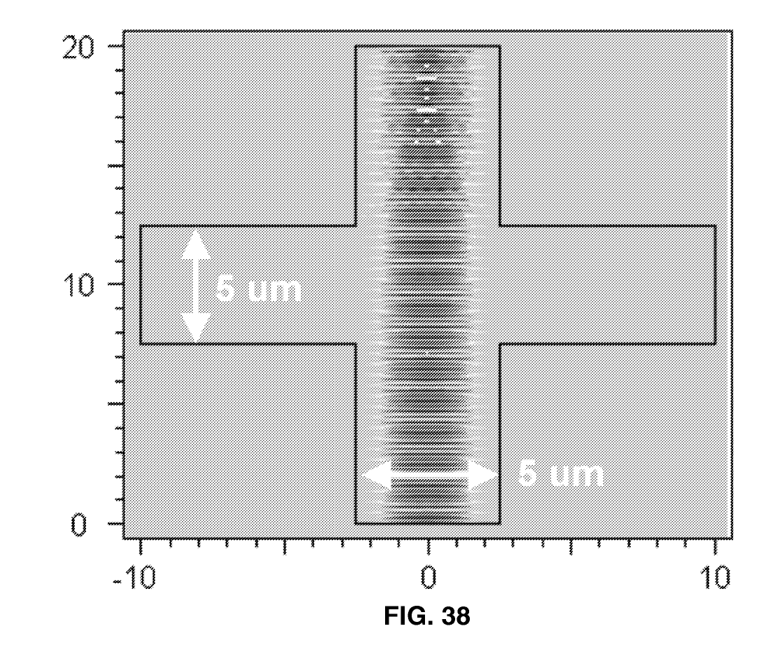

FIG. 37-38 illustrate aspects of waveguide crossings. The configuration of the 4×4 WSXC shown in FIG. 25 involves waveguide crossings for interconnection between the 1×4 MMI splitters and the 4×1 WSSs. However, the intersection causes optical loss and crosstalk. FIG. 37 shows a general geometry of the waveguide crossing. The loss and crosstalk can be reduced with increased intersection angle, yet the tradeoff is a larger device footprint. FIG. 38 shows the two-dimensional (2D) finite difference time domain (FDTD) simulation of a 90° waveguide crossing. An insertion loss of 0.05 dB and a crosstalk of −66 dB were obtained for the 5×5 μm² waveguide. The performance can be further improved with a mode expander at the intersection.

Device Fabrication

The device fabrication process for a WSXC can be the same as utilized in fabricating the monolithic 1×4 WSS previously described, such as fabricated on an SOI wafer with a 5 μm thick device layer. A WSXC was fabricated with the waveguides, reflectors, gratings and MEMS micromirrors all patterned using a one-step etching process. The nitride was deposited by low pressure chemical vapor deposition (LPCVD) as anti-reflection coating on the silicon-air interface. Aluminum was deposited on the sidewall of MEMS micromirrors by evaporation with a 30° tilt angle to enhance reflectivity. The backside of the MEMS micromirror was etched by deep reactive ion-etching (DRIE), followed by a dry release process, in which the buried oxide was removed by plasma etching. The chips were self-separated after dry release, with no cleaving or dicing necessary.

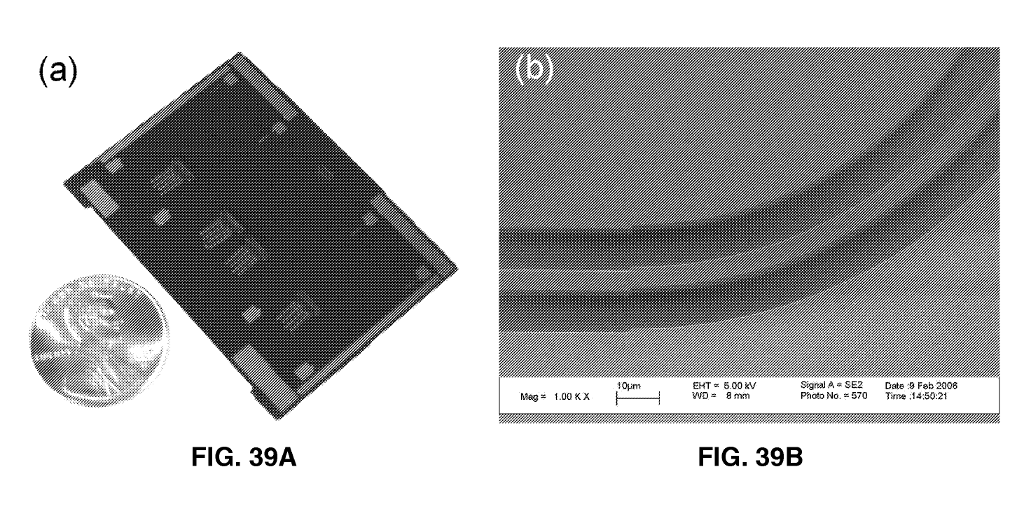

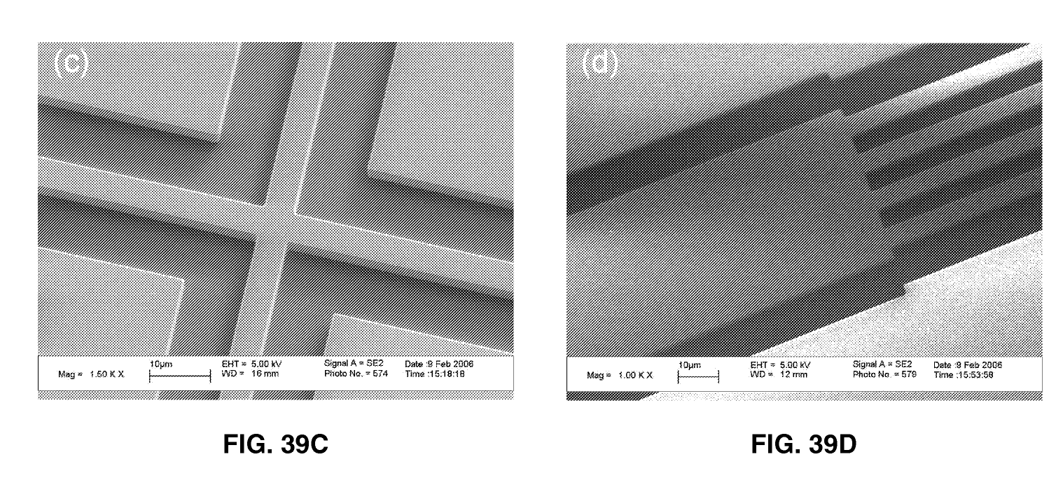

FIG. 39A-39D are photographs and SEM images of the fabricated device. The monolithic 4×4 WSXC has a chip area of 3.2×4.6 cm². A photograph is shown in FIG. 39A comparing the size of the substrate with a penny. The waveguide is defined with 10 μm wide trenches on each side, as shown in FIG. 39B, for optimization of the sidewall profile. The waveguide bending is fabricated with a radius of 100 μm and an offset of 1 μm between the straight and bent sections. The transition is slightly rounded due to the resolution of photolithography and deep silicon etching. Waveguide crossings are shown in FIG. 39C with a 1×4 MMI shown in FIG. 39D.

Experimental Results

The experimental setup for monolithic 4×4 WSXC characterization is similar to that of the monolithic 1×4 WSS. A 12-channel lensed fiber array is mounted on a 5-axis stage for precision alignment to access the input/output waveguides.

Optical Measurement of the 4×4 Wavelength-Selective Cross Connects

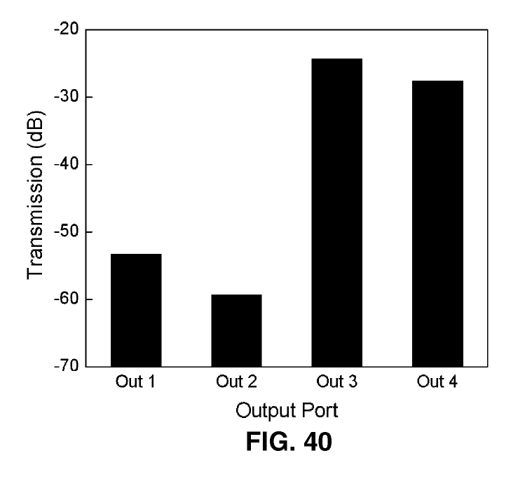

FIG. 40 depicts optical insertion loss characterization by a static device with a fixed mirror. Signals at In 1 were split and distributed to Port 2 of WSS₁ and WSS₂, and Port 5 of WSS₃ and WSS₄. At zero bias, the signals in WSS3 and WSS₄ were reflected to Port 1, and then sent to Out 3 and Out 4. The fiber-to-fiber insertion loss was measured to be 24 dB, which includes the 6-dB splitting loss. The crosstalk was measured at less than −25 dB.

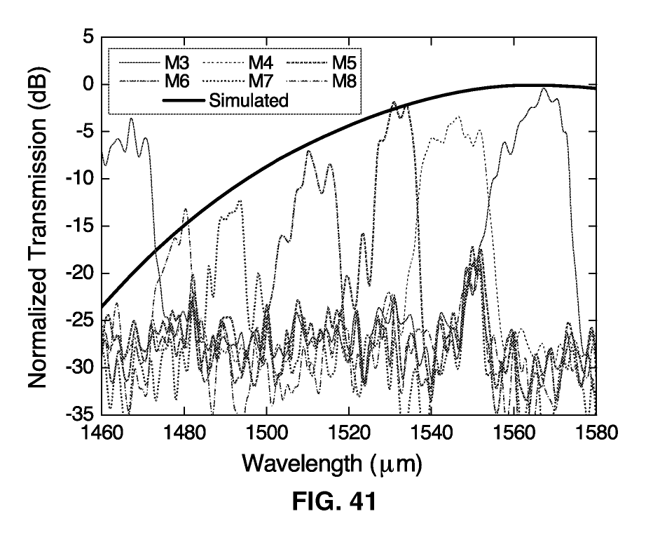

FIG. 41 depicts the spectral response of switching from In 4 to Out 4 by scanning different micromirrors. The spectrum was registered by scanning the laser wavelength from 1460 nm to 1580 nm, and measured by a power meter. In this example, only one micromirror was actuated at a time. The corresponding passband was switched to the output port. Six passbands were demonstrated within the available wavelength tuning range. An extra passband at λ<1472 nm was observed from adjacent grating order. The free-spectral range (FSR) of the 14^{th} order grating used in the current device is 111 nm. A wavelength dependent loss (WDL) of approximately 15 dB is mainly attributable to the grating, which can be reduced by using a lower-order grating.

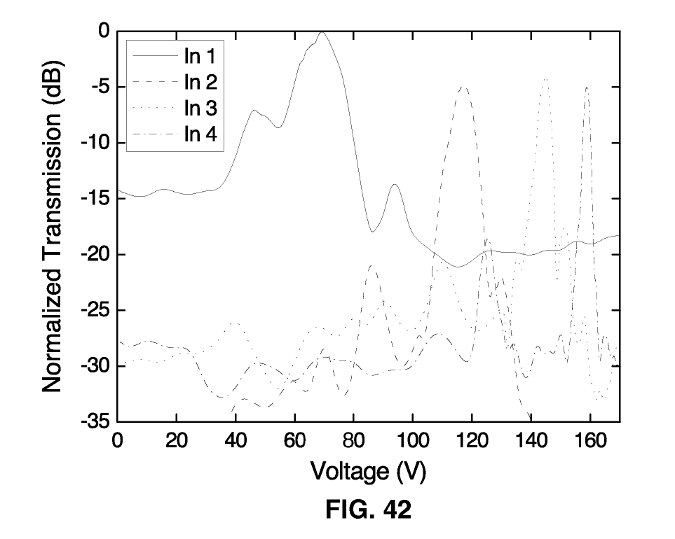

FIG. 42 depicts the transfer curve (transmission-vs-voltage) of Out 4 with inputs from In 1, 2, 3, and 4, respectively. The maximum transmission occurs at 69V, 117V, 145V, 159V, respectively. The dependency of transmission on actuation voltage enables power equalization among different output ports and wavelengths.

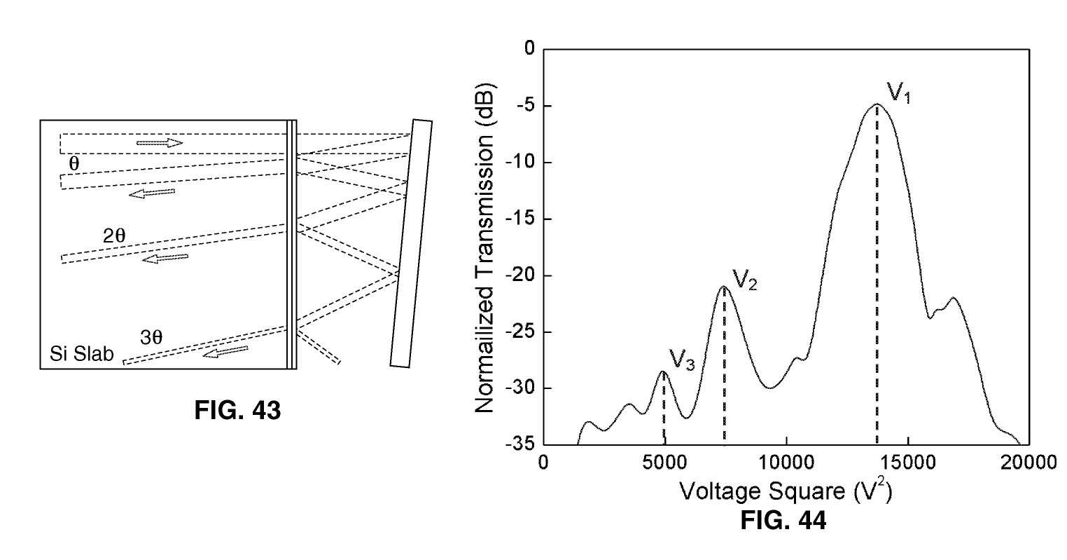

FIG. 43-44 illustrate the effects of imperfect anti-reflective coatings. During testing, it was found that in addition to the major peaks, satellite peaks were observed, which are attributable to imperfect anti-reflection coating. FIG. 43 illustrates an increase of scanning angle after multiple reflections from a surface containing an imperfect anti-reflective coating. Since the mirror rotation angle is proportional to the square of actuation voltage, the transfer curve is plotted with V² as x-axis, as shown in FIG. 44. The value at each peak (V₁², V₂², V₃²) have a ratio of 1:0.53:0.36, which matches with the assumption. The intensity of the satellite peaks can be reduced by using anti-reflection coating material with better matched refractive index.

Breakdown of Insertion Loss

Table 5-1 shows the breakdown of the measured and simulated insertion loss. As described previously the 1×4 WSS has a measured insertion loss of 12 dB. The remainder of the entries in the table were obtained from the measurement of test structures fabricated on the same wafer.

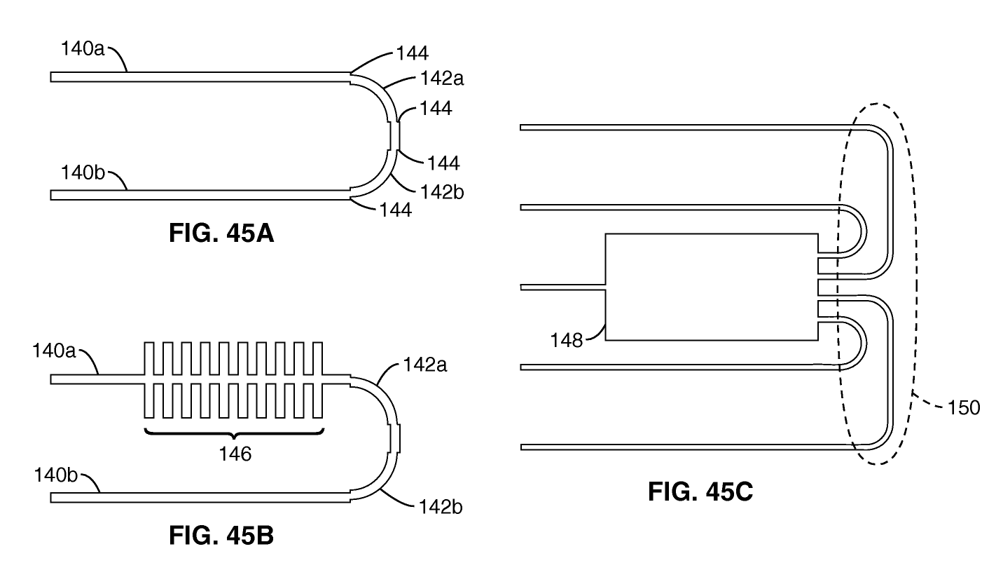

FIG. 45A-45C illustrate test structures on which a bending loss of 0.5 dB/bend was measured. Two 90° bent waveguides 142a, 142b (R=100 μm) were inserted between straight waveguides 140a, 140b, with an optimized offset 144 of 1 μm, which was determined from the measurement of similar structures with various offset. The lower measured loss could be due to the rounded transition caused by fabrication. The bending loss can be further reduced by using the adiabatic bending as described in a prior section.

The waveguide crossing loss was measured with the structure in FIG. 45B, which has ten 90° waveguide crossings 146 added to the structure in FIG. 45A. By measuring similar structures with 20, 30, and 40 crossings, an average of 0.05 to about 0.1 dB/crossing was obtained. The result is close to the FDTD simulated loss of 0.05 dB/crossing.

A splitting loss of 7.5˜9 dB was measured with the structure in FIG. 45C, which comprises a 1×4 MMI and waveguide bendings 150. The higher measured loss and nonuniformity may have been due to the variation of the fabricated slab width, which can be reduced by using modified MMI design with tapered waveguides in relation to FIG. 30.

AWG-Based Wavelength-Selective Switches

A compact WSS can be realized by combining MEMS components and planar lightwave circuits (PLC). Hybrid PLC-MEMS WSS using silica-based arrayed-waveguide gratings (AWGs) and external MEMS micromirrors are known to those skilled in the art. However, bulk lenses are required for collimation and focusing between the PLC and MEMS chips, which require complicated optical alignment and mechanical assembly which lead to reliability concerns and higher costs. This section describes a hybrid PLC-MEMS 1×8 optical switch with an integrated cylindrical lens which eliminates the need for external bulk lenses. Configurations of AWG-based WSS will be introduced for both hybrid PLC-MEMS and monolithic integration.

Hybrid PLC-MEMS 1×8 Optical Switches with Integrated Lenses

Device Design

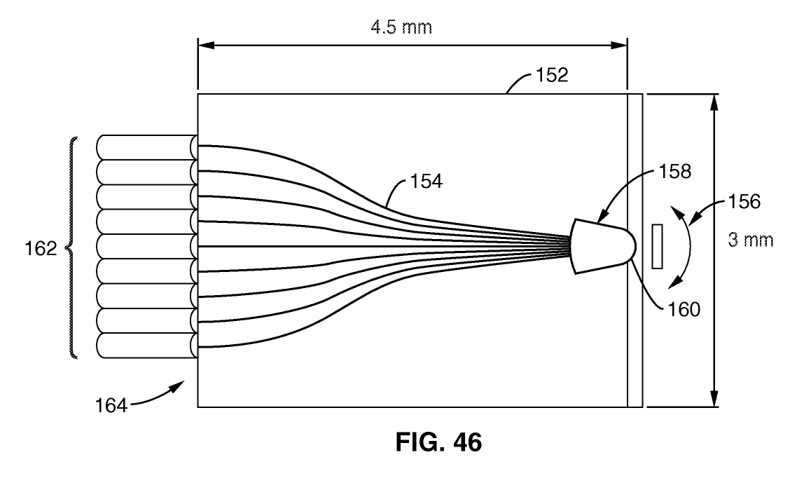

FIG. 46 illustrates an example embodiment of a hybrid PLC-MEMS 1×8 optical switch. This embodiment comprises two chips: a silica-PLC chip 152 with nine waveguides 154, and a MEMS chip 156 with an analog scanning mirror. The waveguides 154 are arranged in a fan shape towards a free propagation slab region 158. A cylindrical lens 160 is microfabricated at the end of slab region 158 to collimate the optical beam and compensate for the beam divergence in the lateral direction. The mirror is positioned at the extrapolated intersection point of the fan waveguide array, taking into consideration the refraction at the silica-air interface.

To facilitate optical packaging, the waveguide spacing is gradually increased to 250 μm at the input end to facilitate coupling between the PLC chip and a fiber ribbon. Silica-PLC chip 152 is shown connected to fiber ribbon 162 such as utilizing a low-loss butt-coupling 164.

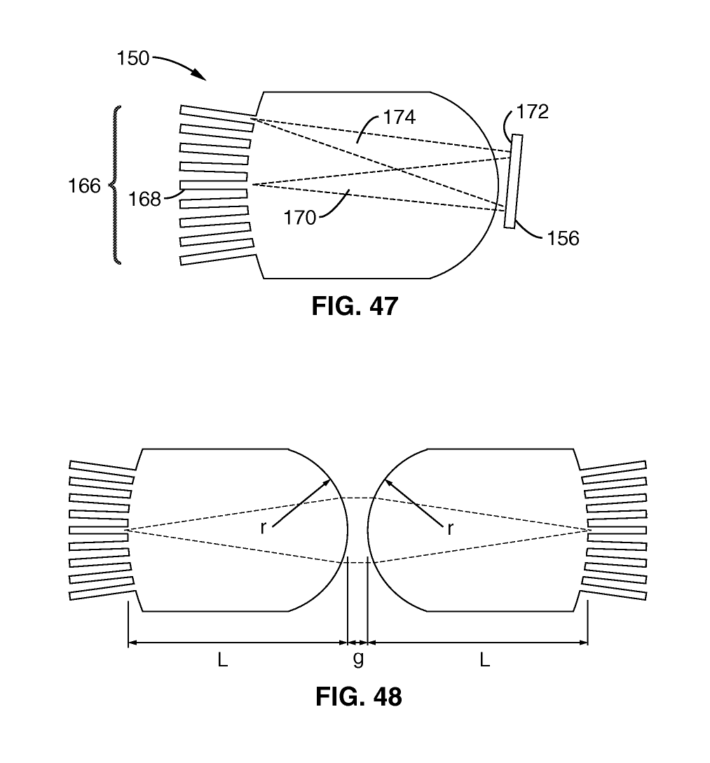

FIG. 47 illustrates an optical schematic of the switch around the slab region 158 from which a plurality of waveguides 166 extend. The center waveguide 168 is used as the input waveguide. The reflected light from the micromirror can be steered to any of the eight output waveguides. An incoming signal 170 is shown from waveguide 168 impinging on mirror surface 172 and being reflected 174 onto another waveguide. The optical beam diverges slightly in the vertical direction between the PLC and the micromirror. To minimize the diffraction loss, the mirror is kept very close to the PLC (˜10 μm).

The design of the slab region and the cylindrical lens is based on the available scanning angle of the MEMS mirror, which is ±5° mechanically. The effective optical scanning angle is ±6.8° considering refraction at silica-air interface. Thus, a slab length of 485 μm is required for the 1×8 switching with a waveguide spacing of 15 μm.

FIG. 48 illustrates the equivalent light path for a round-trip between optical switches in which the cylindrical edge is equivalent to a collimating lens. The beam propagation can be modeled by the ABCD matrix formulation with a combination of free-space propagation and transmission of spherical interfaces:

$$\begin{matrix}[ \begin{matrix}A & B \\ C & D\end{matrix} ] = [ \begin{matrix}1 & L \\ 0 & 1\end{matrix} ] \cdot [ \begin{matrix}1 & 0 \\ \frac{{n}_{1} - {n}_{2}}{{n}_{1} \cdot ( - r )} & \frac{{n}_{2}}{{n}_{1}}\end{matrix} ] \cdot [ \begin{matrix}1 & 2 g \\ 0 & 1\end{matrix} ] \cdot \\ [ \begin{matrix}1 & 0 \\ \frac{{n}_{2} - {n}_{1}}{{n}_{2} \cdot r} & \frac{{n}_{1}}{{n}_{2}}\end{matrix} ] \cdot [ \begin{matrix}1 & L \\ 0 & 1\end{matrix} ]\end{matrix} \qquad ( 21 )$$

where L is the slab length, g is the spacing between the mirror and the microlens, r is the radius of the cylindrical lens, n₁ and n₂ are the refractive indices of silica and air, respectively. A q-parameter is defined as:

$$q = \frac{1}{R} - j \frac{λ}{π {W}^{2}} \qquad ( 22 )$$

where W and R are the beam width and wavefront radius of curvature. The incident and transmitted Gaussian beams, q₁ and q₂, can be calculated as:

$${q}_{2} = \frac{A \cdot {q}_{1} + B}{C \cdot {q}_{1} + D} \qquad ( 23 )$$

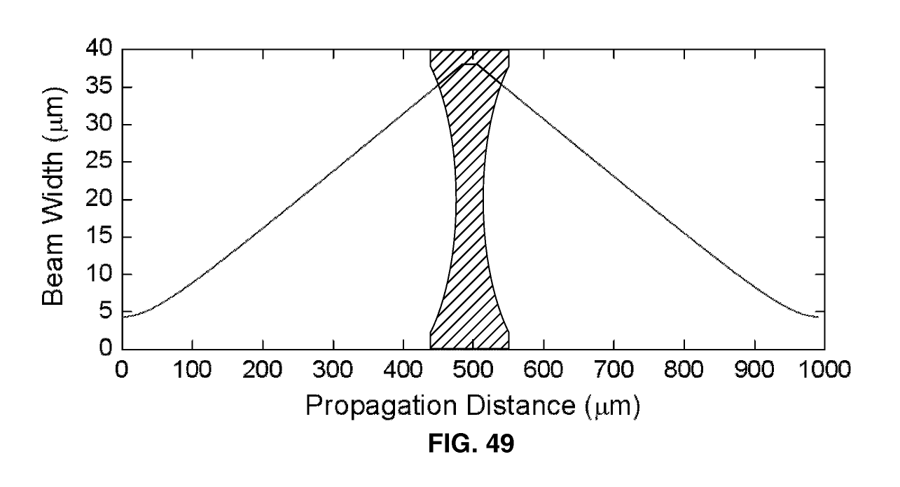

FIG. 49 is a plot of calculated beam width versus propagation distance.

A microlens radius of 155 μm was optimized for the coupling efficiency. The calculated waveguide-to-waveguide insertion loss was as low as 0.5 dB for the 10 μm spacing between the mirror and the microlens. If no microlens is used, the insertion loss will increase to 6.6 dB. This design is insensitive to wavelength and is free of spherical aberration.

Device Fabrication

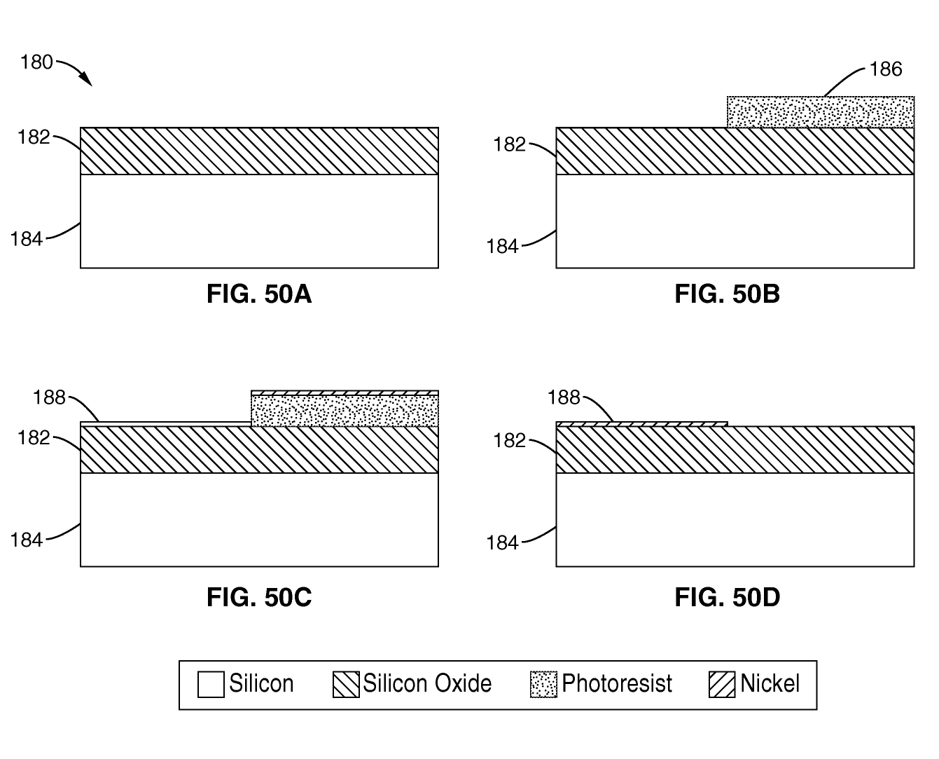

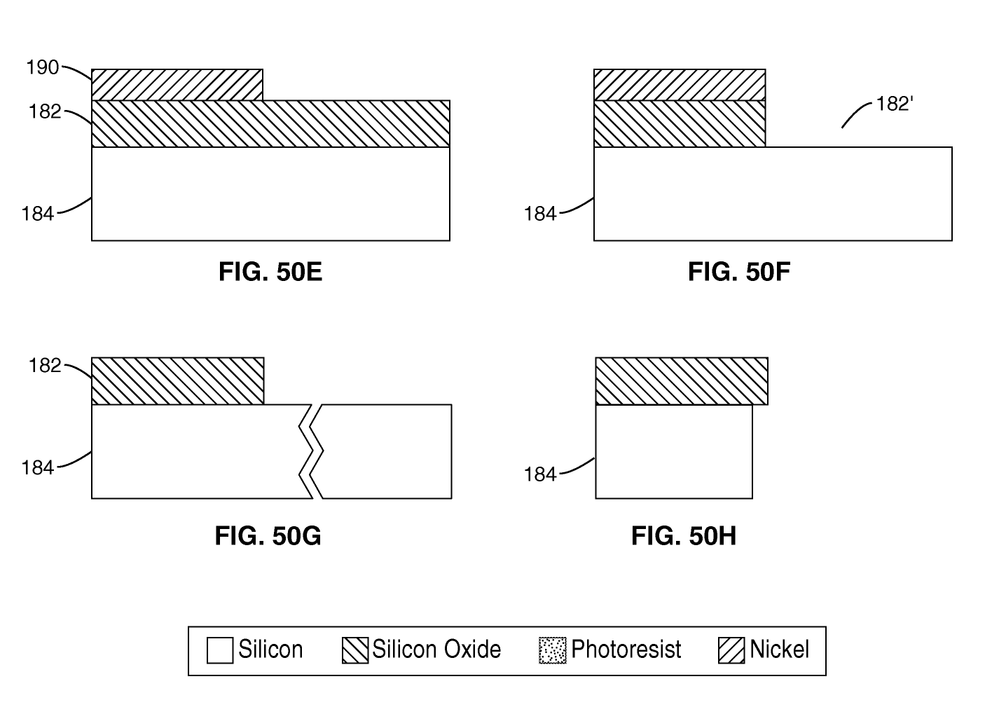

FIG. 50A-H illustrate steps in fabricating an integrated cylindrical lens. Silica-PLC waveguides with a super-high index difference of 1.5% were fabricated by processes similar to the AWG devices known by those skilled in the art. The effective waveguide core sizes was 4.5 μm×4.5 μm. The waveguide bending loss was found to be negligible when the bending radius is greater than 2 mm.

The integrated cylindrical lens was realized on a silica-on-silicon chip 180 of FIG. 50A, having a silica surface layer 182 over a silicon substrate 184, by etching through the 40 μm thick PLC layers using STS Advanced Oxide Etch (AOE). FIG. 50B illustrates mask application 186 over which a thin nickel layer 188 is deposited in FIG. 50C for the lift-off process of FIG. 50D wherein mask 186′ and portion of nickel layer 188′ are removed. The remaining thin nickel layer 188 is electroplated in FIG. 50E, to provide a 4 μm thick electroplated nickel layer 190 as the etching mask. The etching stopped selectively at the silicon substrate as shown in FIG. 50F, thus removing a portion 182′ of the silica layer. After etching away the nickel mask layer 190′, the PLC chip is then preferably diced into individual chips as represented in FIG. 50G and the exposed Si substrate 184′ was selectively etched by gas phase XeF₂ as represented by FIG. 50H.

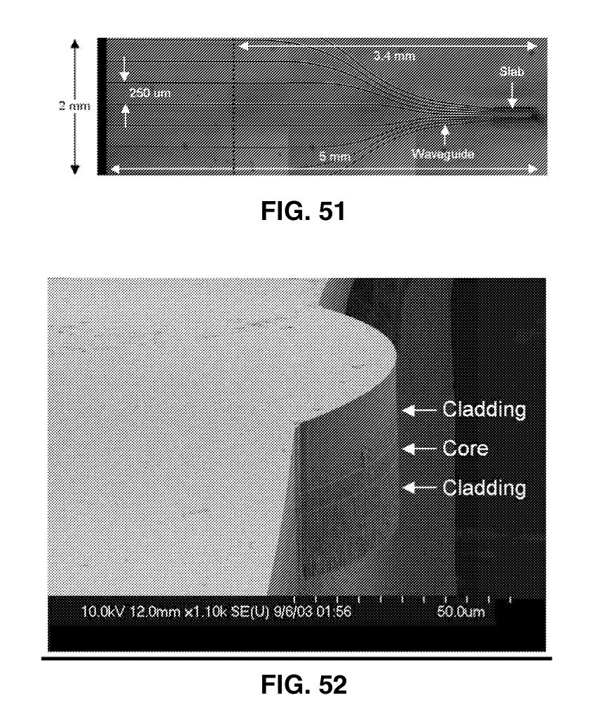

FIGS. 51 and 52 illustrate examples of a fabricated PLC and details of the cylindrical lens at the edge of the PLC chip. FIG. 51 shows an optical micrograph of a fully processed PLC. A detailed view of the on-chip microlens is shown by the scanning electron micrograph (SEM) in FIG. 52. It should be appreciated that a very straight sidewall is achieved for the microlens, with the sidewalls in the upper cladding layer and the core region being very smooth and the lower cladding layer having slightly higher surface roughness.

Experimental Results

The MEMS micromirror used in this configuration was of a conventional type. Using a hidden vertical comb drive actuator underneath the mirror, the scanner has a continuous scan range of ±6° (mechanical angle) at a very low actuation voltage of 8 V. The mirror area (154 μm×160 μm) is 4.8 times larger than the size of the optical beam (1/e diameter=32 μm). The resonant frequency of the mirror is 3.4 kHz. The mirror was made by the surface micromachining process through the SUMMiT-V process at Sandia National Lab.

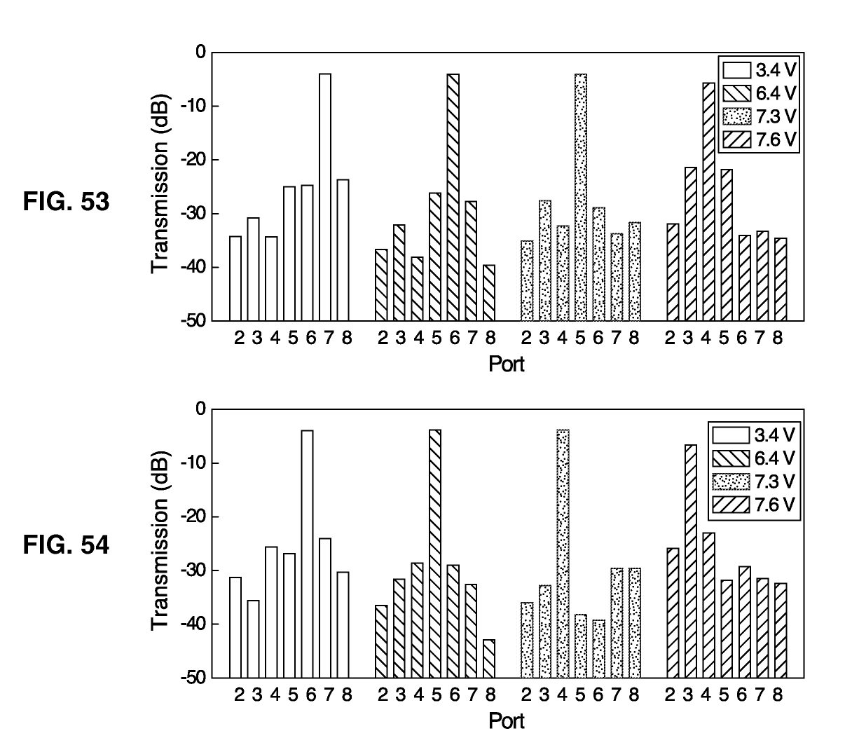

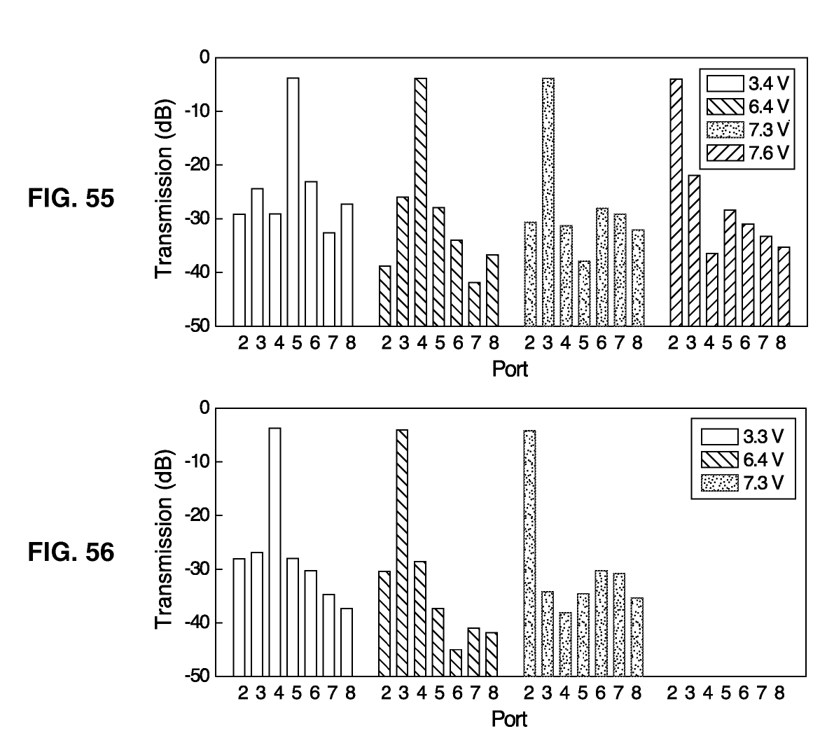

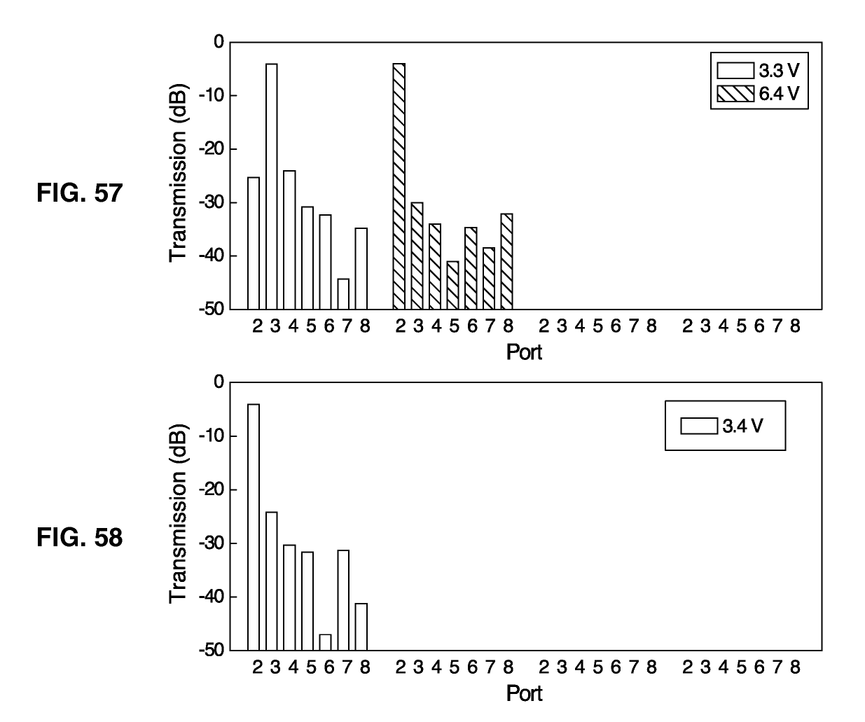

FIG. 53-58 depict transmission performance for ports 2-7 respectively for the hybrid optical switch. In this testing a 12-channel polished fiber array was mounted on a 5-axis stage for precise alignment with the device. The MEMS chip was wire-bonded and mounted vertically on a micropositioning stage. An index-matching fluid was used between the fiber array and the PLC chip for reduction of coupling loss.

The hybrid optical switch was tested using, in turn, port 2 to port 7 as the input. The micromirror was actuated on one side at bias of 3.4V, 6.4V, 7.3V, and 7.6V for switching to various ports. As shown in the bar graphs the fiber-to-fiber insertion loss is typically 3.9±0.2 dB (except the 5.7 dB from port 2 to port 4). This is higher than our theoretical estimation, and appears to be attributable to the non-optimized coupling between fiber and PLC, non-perfect optical alignment, and the residue scattering loss from lens surface. The extinction ratio is measured at greater than 27 dB, and the crosstalk is found to be typically less than −22 dB (except the −16 dB from port 2 to port 4).

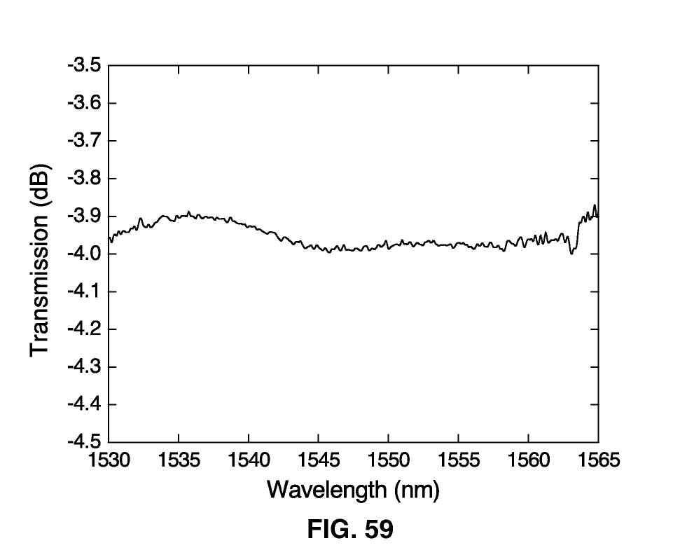

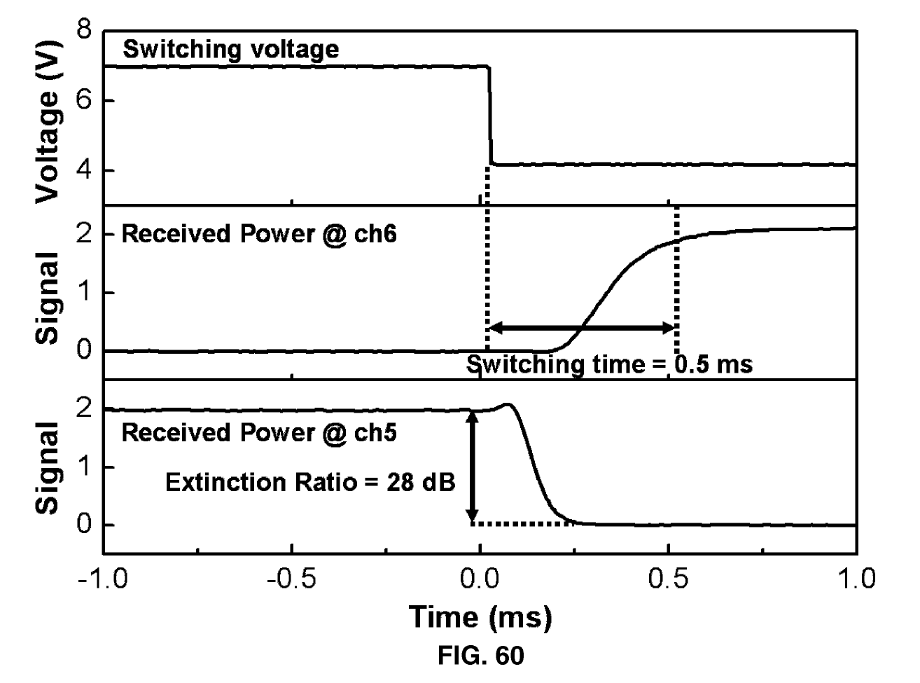

FIG. 59-60 depict characteristics of the PLC-MEMS switch. FIG. 59 depicts a wavelength dependent loss (WDL) of <0.1 dB which was measured using an amplified spontaneous emission (ASE) source and an optical spectrum analyzer (OSA) over C-band (1530-1565 nm). FIG. 60 illustrates a switching time of 0.5 msec measured between port 5 and port 6.

Architectures Of Monolithic AWG-Based WSSs

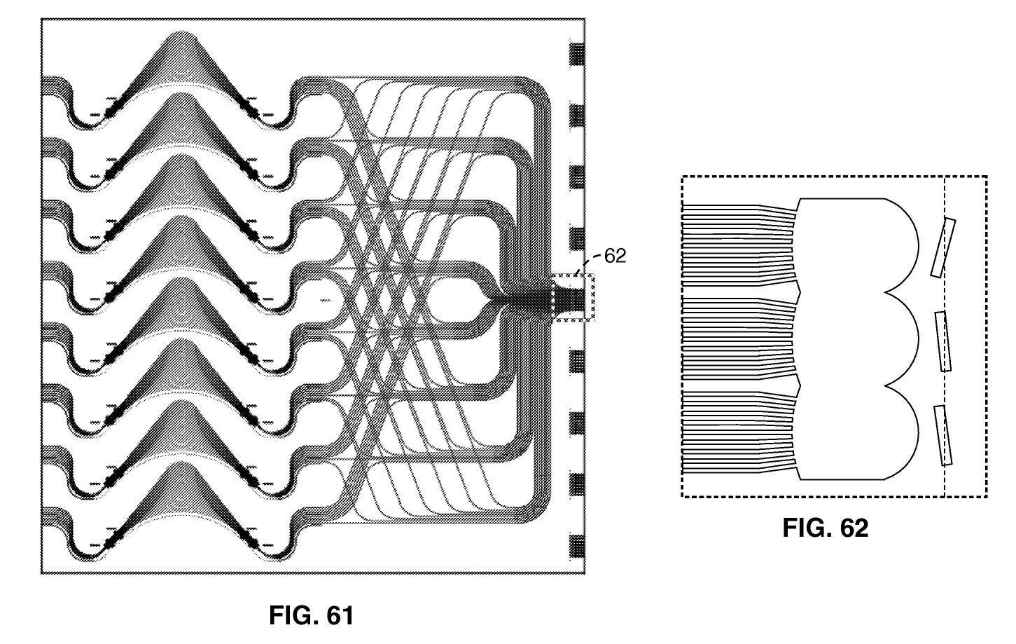

FIG. 61-62 illustrates an AWG based WSS. An AWG is a commercially available waveguide dispersive element. The dispersion is from the optical path difference of the arrayed-waveguides. In this arrangement, wavelengths constructively interfere at various output waveguides. FIG. 61 shows an implementation of the AWG-based 1×7 WSS using our hybrid optical switch utilizing elements described above. A detail of a micromirror array and lensing is shown in FIG. 62. The AWG output waveguides carrying the same wavelength are routed and connected to the hybrid optical switch. The WDM signal can be switched to any port by scanning the micromirror. A micromirror array is integrated for independent switching of each wavelength channel. By using the fan-shape waveguide layout and integrated cylindrical lens, no external lenses are needed. This configuration can be further integrated on a SOI chip using SOI-AWG technologies with on-chip micromirrors. The required scanning angle can be reduced by increasing the slab length. Furthermore, high fill factor is not necessary, which relaxes the design of micromirrors. However, the design includes a large number of waveguide intersections, which leads to higher insertion loss and crosstalk.

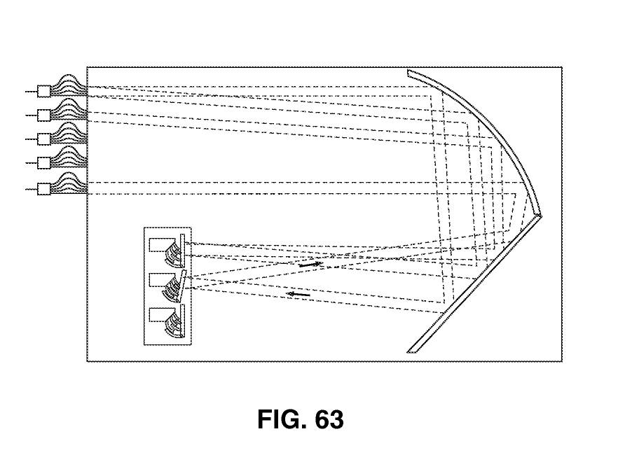

FIG. 63 illustrates an alternative embodiment of the monolithic WSS, which has many similar elements to that of FIG. 1. AWGs can be used as conventional gratings by terminating the output star coupler with an infinite radius, which is similar to the reported hybrid PLC-MEMS WSS. Instead of external bulk lenses, the integrated curved reflector is used as in our grating-based WSS as described with respect to FIG. 1. The dispersed light is focused onto a micromirror array for independent switching of each WDM channel. The reflected light propagates in the reverse direction, where it is imaged by the focusing reflector and re-multiplexed by the AWGs.

Optical System Design Flow

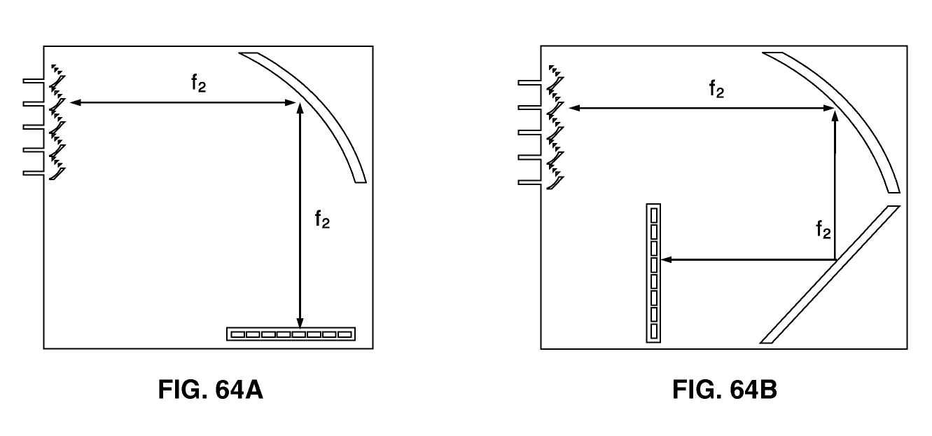

FIG. 64A-64B illustrate unfolded and folded configurations of MEMs-based WSSs. The monolithic MEMS-based WSS described above can be realized by integrating channel waveguides, parabolic reflectors, transmission gratings, and micromirrors in a 4-f confocal configuration on SOI platform as shown in FIG. 64A. The system footprint can be reduced by inserting a folding reflector between the focusing reflector and the micromirror array as shown in FIG. 64B.

The optical system is preferably designed according to the following procedures:

(a) Use the following to determine the micromirror pitch (Pₘ) by the specified port count and available optical scan angle θₛ:

$$Port Count = \frac{{θ}_{s}}{{Δθ}_{s}} + 1 = \frac{π {W}_{m} {θ}_{s}}{2 {ξ}_{c} λ} + 1 = \frac{π {P}_{m} {θ}_{s}}{4 {ξ}_{m} {ξ}_{c} λ} + 1 \qquad ( 24 )$$

where θₛ is the available optical scan angle of the micromirror. A large micromirror pitch Pₘ and a large scan angle θₛ are desired for higher port count. Since micromirrors switch light in the air, the effective scan angle in the silicon slab is reduced by the refraction at the silicon-air interface:

$${θ}_{s} = {sin}^{- 1} ( \frac{sin 2 {θ}_{mech}}{n} ) \qquad ( 25 )$$

where θ_{mech} is the mechanical scan angle of the micromirror.

(b) Design the micrograting for maximum angular dispersion (D) based on the restriction of critical angle for total internal reflection and microfabrication capabilities for the geometric shape and the sidewall profile of the grating elements.

(c) Determine the focal length of the focusing reflector (f₂) by the channel spacing (Δλ), grating angular dispersion (D), and the micromirror pitch (Pₘ):

$${f}_{2} = \frac{{p}_{m}}{tan ( D \cdot Δ λ )} \qquad ( 26 )$$

Since the footprint of the WSS is primarily determined by f₂, a large grating dispersion is desirable.

(d) Determine the focal length of the collimating reflector (f₁) by

$${f}_{1} = {f}_{2} \cdot \frac{{W}_{o}}{{W}_{m}} = \frac{2 \cdot {f}_{2} \cdot {ξ}_{m} \cdot {W}_{o}}{{D}_{m}} \approx \frac{2 \cdot {f}_{2} \cdot {ξ}_{m} \cdot {W}_{o}}{{P}_{m}} \qquad ( 27 )$$

where f₁ and f₂ are the focal lengths of the collimating lens and the focusing lens, respectively, and wherein Wₒ and W_{M} are the Gaussian beam width at the waveguide and the micromirror, respectively. Dₘ is the micromirror width, which is close to Pₘ for high fill-factor mirror array.

(e) Determine the width of the collimating reflector (D_{c}) by:

$${D}_{c} = {ξ}_{c} \cdot {W}_{c} = {ξ}_{c} \cdot {W}_{o} \cdot \sqrt{1 + {( \frac{{λ}_{o} \cdot {f}_{1}}{n \cdot π \cdot {W}_{o}^{2}} )}^{2}} \qquad ( 28 )$$

where W_{c} is the Gaussian beam width at the collimating reflector, λₒ is the free-space wavelength, and n is the refractive index.

(f) Determine the width of the focusing reflector (D_{f}) by the port count (1×N), pitch of collimating reflectors (P_{c}), number of wavelength channels (K), and dispersion of grating (D) as:
D_{f}=N·P_{c}+D·Δλ·f₂·K (29)
The second term in Eq. 29 equals to the width of the micromirror array. Therefore Eq. 29 can be rewritten as:
D_{f}=N·P_{c}+K·Pₘ (30)

Table 6 summarizes the design parameters of the monolithic 1×4 WSS for CWDM and DWDM applications.

Silicon-Based On-Chip Micromirrors

Actuation Mechanisms

Micromirror actuation can be realized by electrostatic, thermal, electromagnetic, or piezoelectric mechanisms known to those skilled in the art. Electrostatic actuators are particularly attractive because of their low power consumption, low temperature dependence, and simple mechanical structures.

Electrostatic actuators typically consist of two electrodes; one which is fixed, and the other which is connected to a compliant suspension. The electrostatic force between the two electrodes is balanced by the mechanical restoring forces of the compliant suspension. Parallel-plate actuators are used for many applications, but pull-in instability limits the stable travel range to a third of the initial gap. On the other hand, comb-drive actuators offer a large travel range in the direction parallel to the comb fingers, while the gap is unaffected during motion.

Rotary Comb-Drives

Device Design

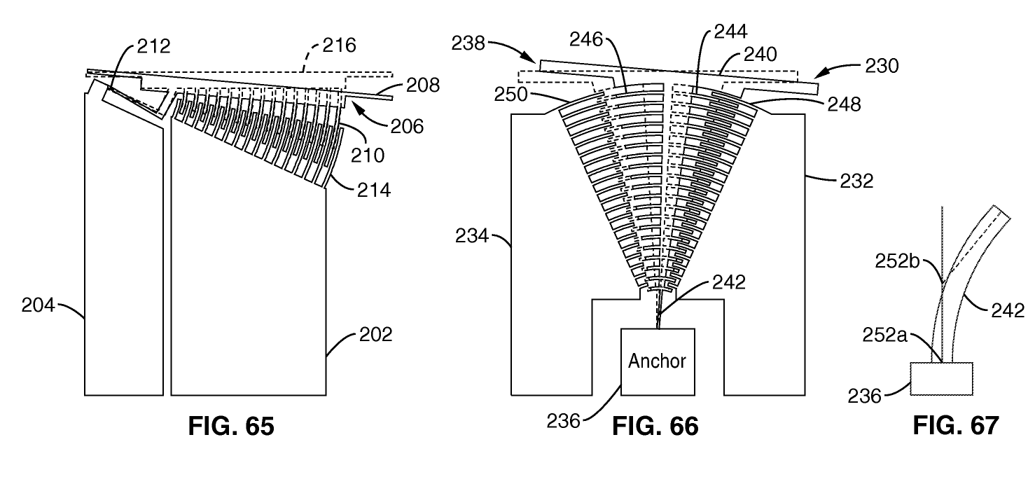

FIG. 65-66 illustrate embodiments of rotary comb-drives having uni-directional and bi-directional deflection. An embodiment 200 of unidirectional deflection mirror is shown in FIG. 65 and provides angular mirror deflection by utilizing a rotary comb-drive actuator. The comb fingers are arranged in concentric arcs to ensure a constant finger gap for the curved contour of rotation. The uni-directional mirror 200 is configured with a base 202 and anchor 204 from which extends a moving element 206 having a mirror surface 208 and comb fingers 210, which being attached to moving element 206 are often referred to as moving comb fingers. Moving element 206 is shown attached to anchor 204 through a compliant spring element 212. Stationary comb fingers 214 extend from base 202 toward interposition between moving comb fingers 210. Displacement of the mirror from initial position 216 is in response to the application of an actuating voltage between the anchor and base, and thus between the moving and stationary comb fingers drawing them into interposition.

As shown in Table 6, the CWDM 1×4 WSS requires a mechanical scan angle of 4.8° with a mirror pitch of 400 μm. FIG. 65 illustrates the design of a unidirectional micromirror having a width of 390 μm and a fill factor of 97.5%. The 15-finger rotary comb-drive has a finger width of 4 μm and a finger gap of 3 μm. The movable comb is supported by a flexure spring with a length of 70 μm and a width of 3 μm. The spring constant can be evaluated by:

$${k}_{x} = \frac{{Ew}_{s}^{3} t}{4 {l}_{s}^{3}} \qquad ( 31 )$$

where E=160 GPa is the Young's modulus for silicon, wₛ is the beam width in the bending direction, Iₛ is the beam length, and t is the thickness of the spring. The calculated spring constant is 15.7 N/m. The resonant frequency calculated by finite element method is 13.8 kHz.

FIG. 66 illustrates an embodiment 230 of a bi-directional micromirror. The movable structure is supported by a flexure spring at the center with symmetric rotary comb-drives on both sides. A first base 232 and second base 234 are shown between which is an anchor 236. A moving element 238 with mirror surface 240 extends from anchor 236, attached through spring 242. First and second sets of movable comb fingers 244, 246 extend from the moving element 238 and interpose, respectively, between fixed comb fingers 248, 250 of first and second bases 232, 234. In this case three electrodes (first base 232, second base 234, and anchor 236) are provided by which displacement can be driven in a pull, push, or more preferably push-pull manner between the two sets of stationary combs.

This arrangement can achieve approximately twice the mechanical scanning angle of the unidirectional micromirror of FIG. 65. However, the larger lateral offset limits the fill factor of the micromirror array, which reduces the usable optical bandwidth of each passband.

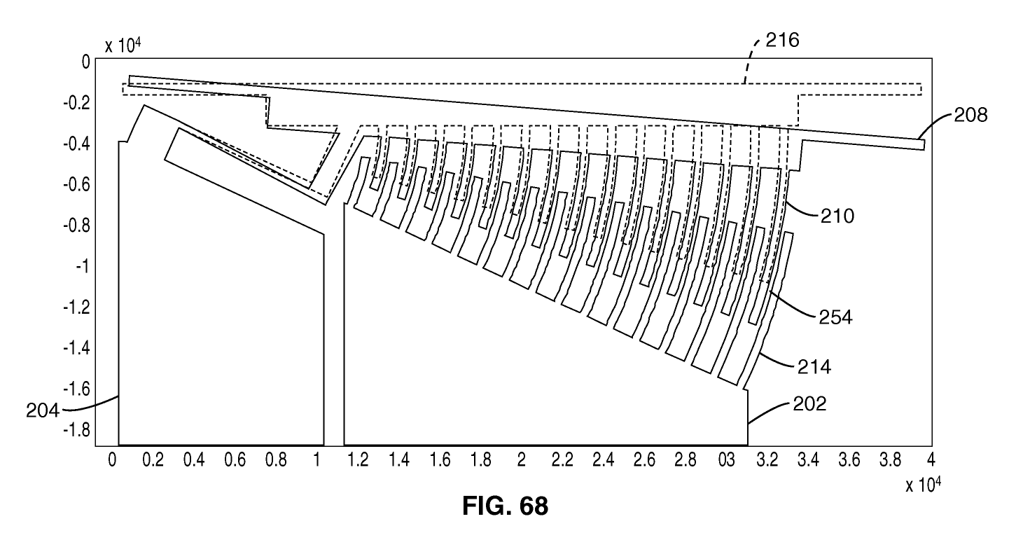

FIG. 67-68 illustrate mirror rotation issues with lateral stability. The lateral instability experienced with a linear comb-drive is also an issue for the rotary comb-drive. As shown in FIG. 67, the bending of the cantilever beam is accompanied with a shift of the effective rotation center from the designed center 252a to shifted rotation center 252b. This leads to a shift of the comb fingers from the equilibrium position, as shown by narrowing 254 of interfinger gap in FIG. 68. Once the unbalanced force in radial direction exceeds the transverse stiffness, the moving comb will collapse to the stationary comb, which limits the angular deflection of the micromirror.

Device Fabrication and Characterization

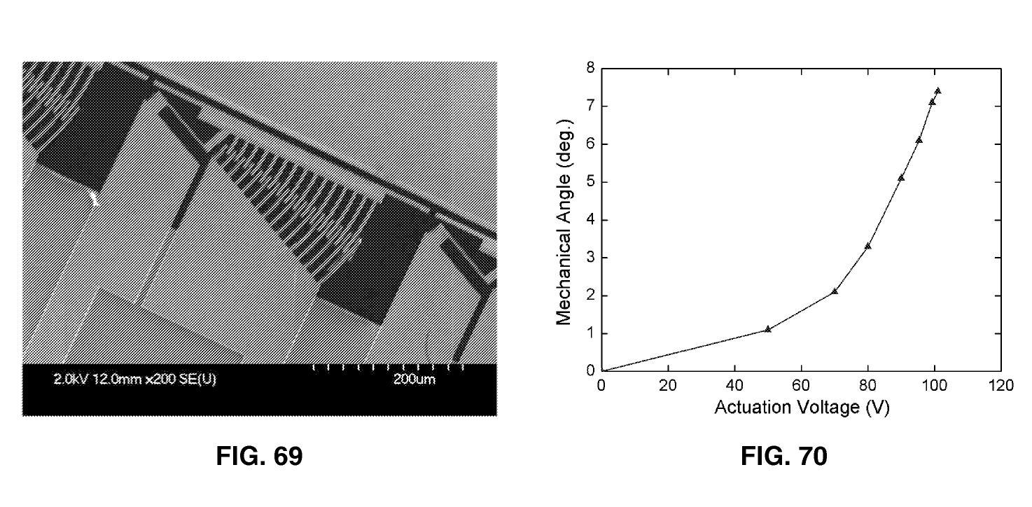

FIG. 69 illustrates an SEM image of an example uni-directional micromirror device fabricated on a 4-inch SOI wafer with a 5 μm thick device layer. The on-chip micromirrors were etched in an Applied Materials Precision 5000 etcher. Low stress silicon nitride was deposited on the sidewalls by low-pressure chemical vapor deposition (LPCVD) as anti-reflection coating. The mirror surface was coated with a reflective material, specifically a 100 nm thick aluminum layer by e-beam evaporation with a 30° tilting angle. The backside of the wafer was etched by deep reactive ion etching (DRIE), followed by a dry release process, in which the buried oxide was removed by a plasma etch. The fabricated micromirror was tested by applying a DC bias across the movable and the stationary combs and movement of the mirror registered.

FIG. 70 depicts the DC characteristics of mechanical angle in response to actuation voltage for the unidirectional mirror assembly of FIG. 69. This example micromirror exhibited a maximum mechanical scan angle of 7.4° at a driving voltage of 101V.

Lateral Comb-Drives

Device Design

The DWDM 1×4 WSS shown in Table 6 requires a mechanical scanning angle of 9.2° with a mirror pitch of 75 μm. The smaller mirror pitch is due to the reduction of the channel spacing from 20 nm (CWDM) to 0.8 nm (DWDM). The footprint of the rotary comb-drive described previously is too large for this switch.

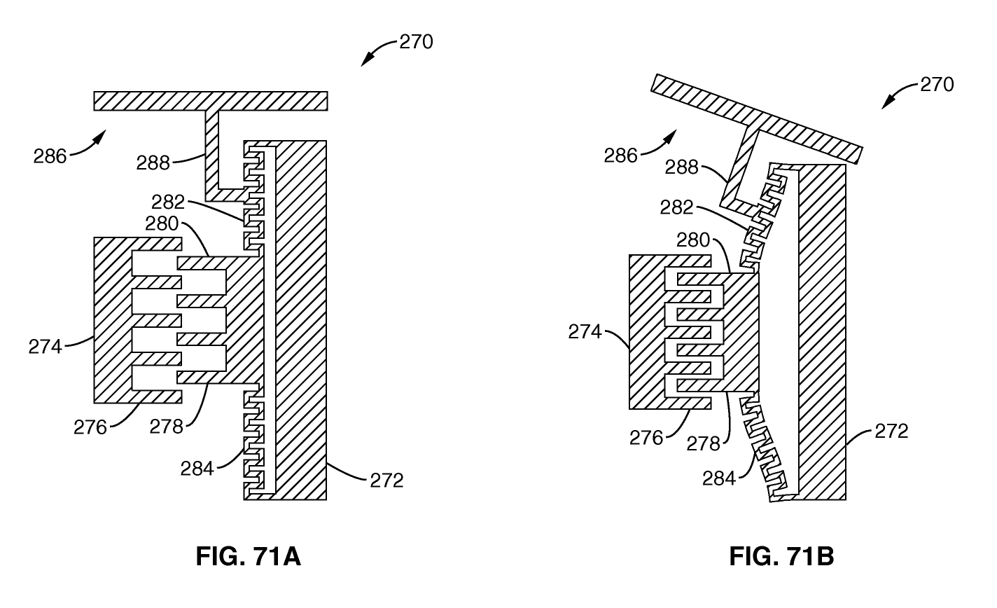

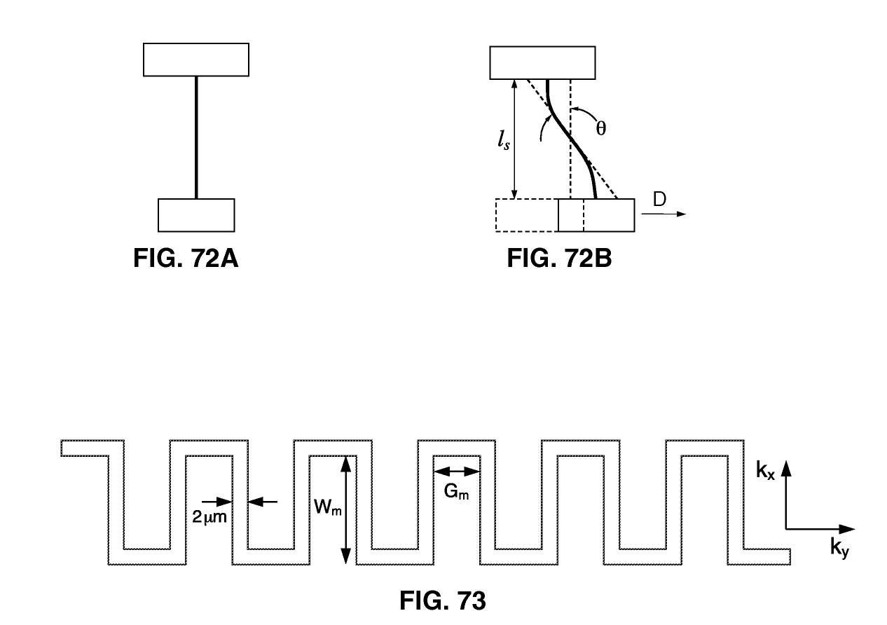

FIG. 71A-71B illustrates an example embodiment 270 of a lateral comb-drive micromirror design, shown in a non-deflected first position in FIG. 71A and a fully deflected second position in FIG. 71B. A first base 272, and second base 274 are shown from which a set of stationary comb fingers 276 extends. A movable element 278 is shown with a set of movable comb fingers 280 directed for interposition between stationary comb fingers 276. Flexure springs 282, 284 couple movable element 278 to first base 272. A movable element 286 with micromirror 290 is attached through actuator element 288, shown as an L-shaped arm, to one of the flexure springs 282, such as attached to the middle of spring 282. From FIG. 71A the linear comb-drive moves laterally in response to a non-zero bias voltage between the combs and the bending of the beam translates linear motion into angular deflection of the attached mirror with full deflection shown in FIG. 71B.

FIG. 72A-72B illustrates the bending of a linear spring. The maximum angle occurs in the middle as given by:

$$θ = 1.5 \frac{D}{{l}_{s}} \qquad ( 32 )$$

where D is the displacement and Iₛ is the spring length. Short spring length is desired to achieve large mirror angle since the displacement is limited by the small pitch. However, the required force Fₓ=kₓ·D increases due to the larger spring constant, which can be calculated by:

$${k}_{x} = \frac{{Ew}_{s}^{3} t}{{l}_{s}^{3}} \qquad ( 33 )$$

The actuation force can be increased by increasing the operating voltage or adding more fingers in the direction perpendicular to the array, while keeping the mirror pitch constant. However, the micromirror with the linear spring will have a suspended length of a few millimeters, which may not be practical for 75-μm mirror pitch because of instability and stiction issues during operation.

FIG. 73 illustrates an embodiment 294 of a serpentine spring having a plurality of bends 296a, 296b, 296c . . . 296n. The use of the serpentine spring aids in overcoming stability and stiction issues. The spring is shown with an element thickness of 2 μm. Springs with large k_{y}/kₓ are desired for lateral stability as well as low operating voltage. The spring constant kₓ in the bending direction can be reduced by increasing the number of meandering (i.e., smaller Gₘ), or increasing meandering width Wₘ. However, the spring constant k_{y} along the spring length is also reduced, lowering the threshold for lateral instability.

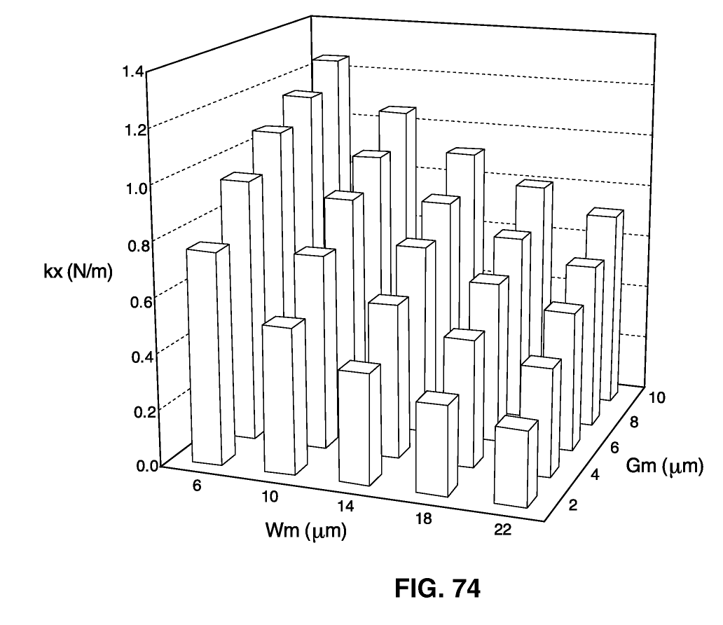

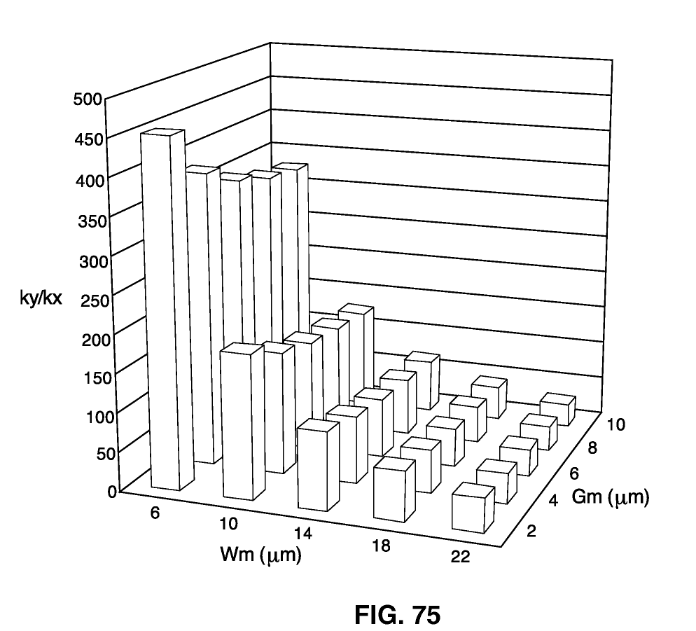

FIG. 74-75 illustrate theoretical spring constant kₓ and the spring constant ratio k_{y}/kₓ, respectively, for the serpentine configuration shown in FIG. 73. For these figures, the spring was simulated using finite element method (FEM), specifically using FEMLAB (v. 3.1, COMSOL). The structural mechanics module is used with a Young's modulus of 160 GPa, a Poisson's ratio of 0.27, and a density of 2.3 g/cm³ for Si. The spring constant ratio k_{y}/kₓ increases with reducing Wₘ or Gₘ. Design rule conclusions which were drawn from this are to minimize Gₘ for a maximum number of meanderings, and then increase Wₘ to obtain the desired spring constant kₓ.

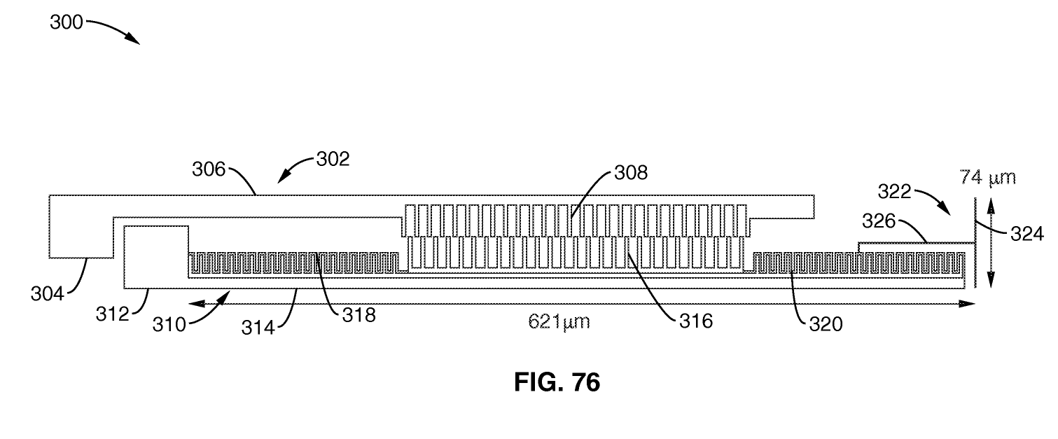

FIG. 76 illustrates an example embodiment 300 of a micromirror. In this example configuration a base 302 is shown with probing pad 304 and elongate section 306 from which extend a plurality of stationary comb fingers 308. An anchor 310 is shown with probing pad 312 and elongate section 314. A movable set of comb fingers 316 is retained intermediate elongate section 314 with a first spring 318 and second spring 320. Movable comb fingers 316 are configured for actuated interposition with stationary comb fingers 308. A movable structure 322 is shown having a mirror surface 324 and an actuator element 326 coupled to spring 320.

In the example mirror of FIG. 76, the serpentine springs 318, 320 each have a spring length of 174 μm, a spring width of 2 μm, a meandering gap of 2 μm, and a meandering width of 6 μm. The 27-finger comb-drive has a finger gap of 2 μm, a finger width of 3 μm, a finger length of 25 μm, and an initial overlap of 1 μm. The total length of the suspended structure is reduced to 621 μm. A resonant frequency of 18 kHz is simulated using the frequency response analysis of FEMLAB.

Device Fabrication and Characterization

The micromirror of FIG. 76 was fabricated on a 6-inch SOI wafer with a 5 μm thick device layer. The micromirror was etched in an Applied Materials Centura etcher, and released in a vapor hydrofluoric (HF) chamber. The fabricated device was tested by applying a DC bias across the moving and stationary combs.

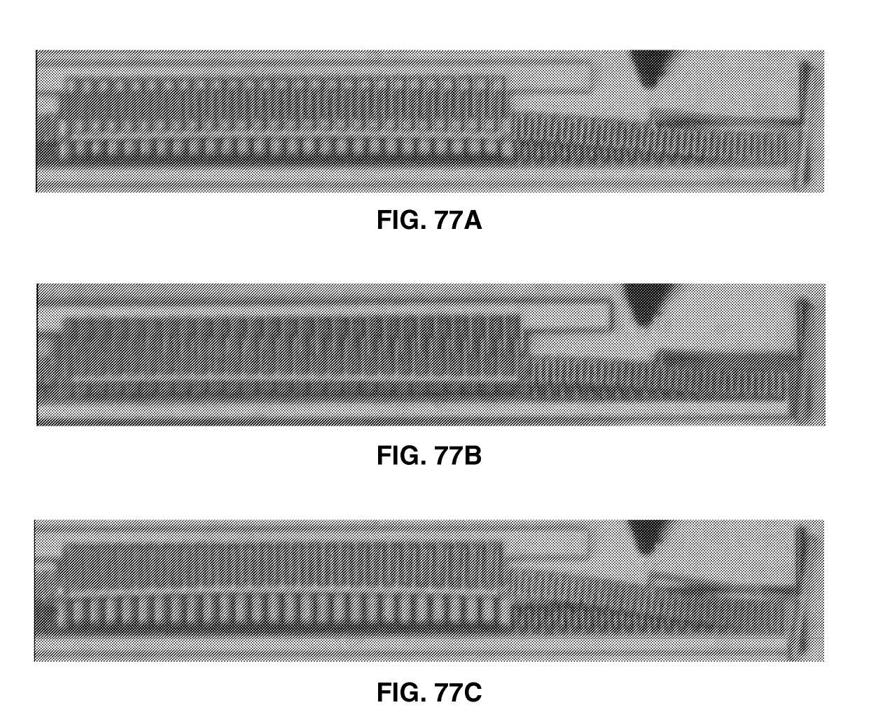

FIG. 77A-77C shows an actuation sequence of the fabricated micromirror. The scanning angle is limited by lateral instability and longitudinal pull-in effect, which are evident in FIG. 77A and FIG. 77C, respectively. The lateral instability is mainly caused by the bending of the backbone of the movable comb, which can be improved by increasing its width. The pull-in is due to the interaction of the fringing fields when the moving and stationary combs are too close.

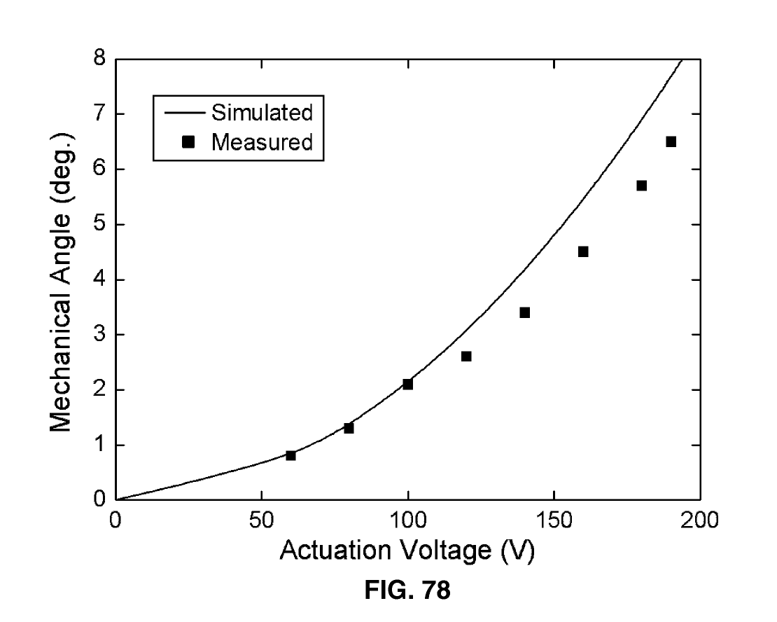

FIG. 78 is a graph of the theoretical and measured DC characteristics of the micromirror of FIG. 76 and FIG. 77A-77C, respectively. The scan angle is simulated using the mechanical analysis of ANSYS (v. 8.1, ANSYS Inc.), while the actuation force applied on the tip of fingers is calculated by Eq. 33. A maximum mechanical angle of 6.5° has been achieved experimentally at a bias of 190 V.

Solid Immersion Micromirrors

Device Design

From the previous discussion, switching in wavelength-selective switches can be realized by the on-chip micromirror with the rotary comb-drive or the lateral comb-drive actuators. However, there are two drawbacks when using conventional flat front micromirrors in such systems: (1) the deflection angle is reduced when the light beam re-enters the Si slab; and (2) the large air gap between the slab and the mirror results in high diffraction loss.

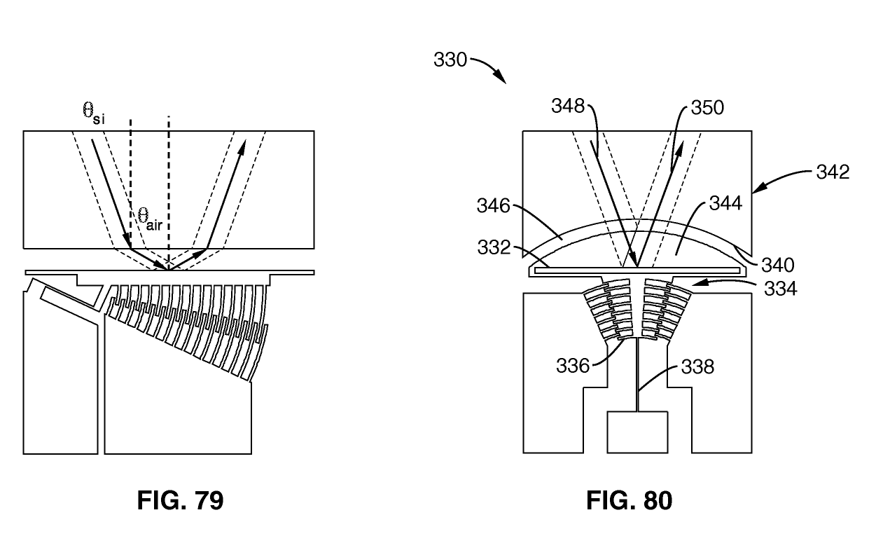

FIG. 79 illustrates a schematic for a flat micromirror driven by a rotary comb-drive actuator. The effective scan angle θ_{eff} is reduced by refraction at silicon-air interface:

$${θ}_{eff} = {sin}^{- 1} ( \frac{1}{n} \cdot sin θ ) \approx \frac{θ}{n} , \qquad ( 34 )$$

where θ is the free-space optical scan angle, and n=3.48 is the refractive index of Si. Therefore, about 3.5 times larger mechanical scan angle is required for the micromirror.

FIG. 80 illustrates an example embodiment 330 of an on-chip solid immersion micromirror (SIM). A curving movable element 332 is shown configured for being driven in response to the interaction of the fixed and movable combs 334, 336, respectively, through spring 338. Curved moving element 332 rotates within a curving portion 340 of the waveguide region 342. Instead of using the front Si-air interface, as in previous examples, this embodiment utilizes a micromirror created on the back interface 344, such as by a metal coating. The air gap 346 between the Si slab and the SIM follow a curved contour so that light always passes through the Si-air interface at nearly normal incidence, as shown by arrows 348, 350. The sidewall of the gap is preferably coated, such as with silicon nitride, to reduce Fresnel loss. The deflection angle inside Si slab is enhanced by approximately 3.5 times compared with conventional flat front micromirrors. This concept of operation is analogous to that of the solid immersion lens and immersion grating.

The SIM also reduces diffraction loss, which is another drawback of the flat micromirror configuration. It will be appreciated that the optical beam diverges when propagating in the air gap giving rise to a diffraction loss when light is coupled back to the silicon slab.

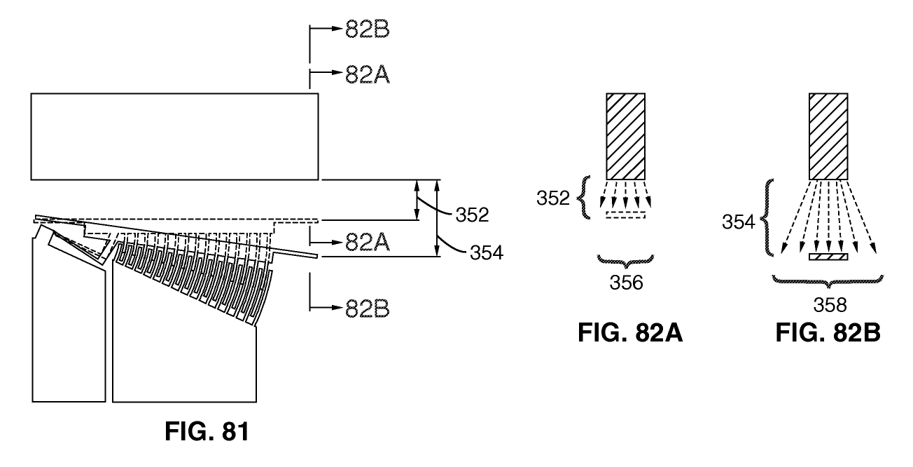

FIG. 81-82B illustrates a unidirectional mirror assembly and the associated diffraction patterns in response to air-gap changes. FIG. 81 depicts the unidirectional mirror assembly described in a prior section. FIG. 82A, 82B illustrate cross-section views with arrows representing the higher angular diffraction losses which arise as the air gap widens between 352 to 354 with increased rotation angle for the flat micromirror, which causes higher and angular dependent diffraction loss as represented by the increased optical spread moving from width 356 to the larger width 358.

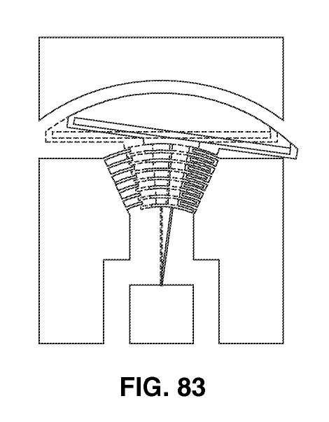

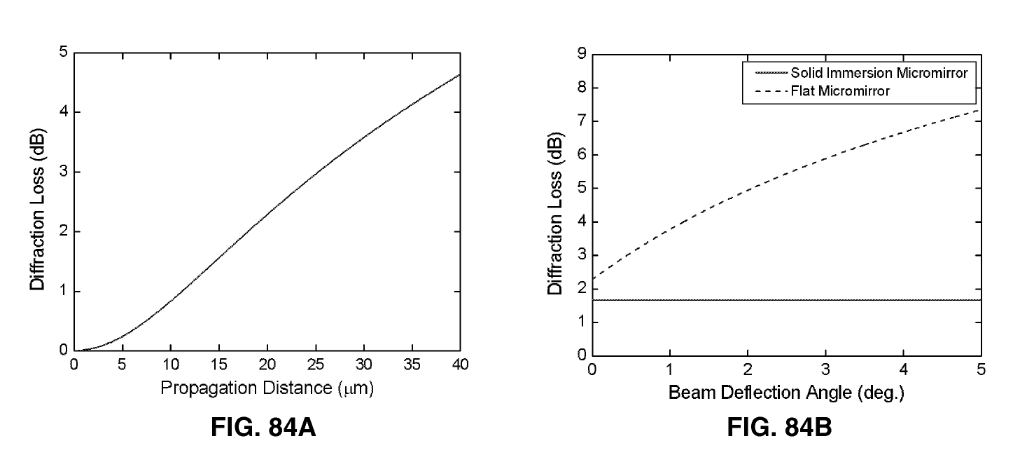

FIG. 83 illustrates an SIM as described in FIG. 80, shown at an end and intermediate position, wherein it can be seen that the gap distance remains constant during rotation because the mirror trajectory follows the curved interface. This significantly reduces the diffraction loss, especially for large rotation angles. FIG. 84A shows the dependence of diffraction loss on propagation distance, while FIG. 84B shows deflection angle for flat and solid immersion micromirrors.

Device Fabrication and Characterization

The fabrication of SIM is similar to that described in relation to FIG. 66. After silicon etching and LPCVD of silicon nitride, the mirror surface on the back interface was coated with a reflective coating, in particular a 100 nm thick aluminum by e-beam evaporation with a 30° tilting angle.

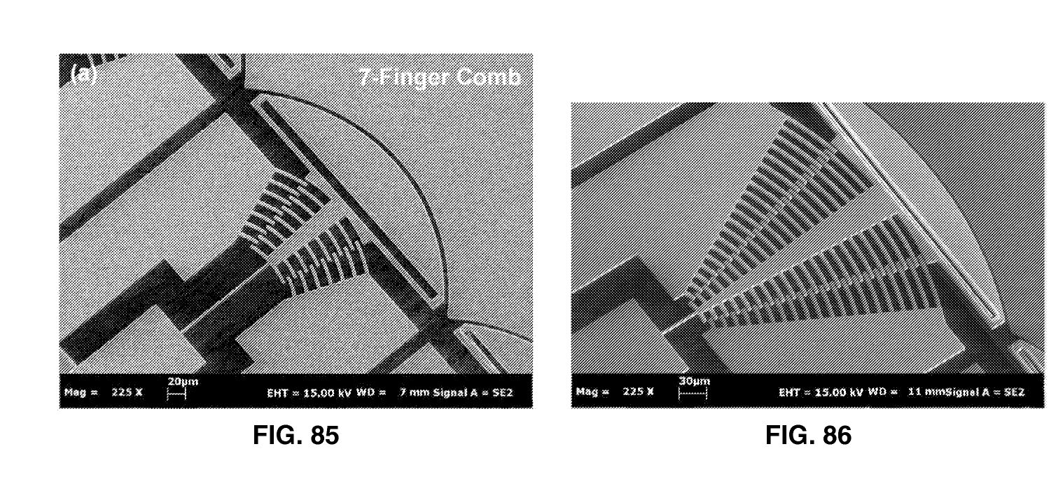

FIG. 85-86 shows scanning electron micrographs (SEM) of fabricated solid immersion micromirrors with 7-finger (FIG. 85) and 20-finger (FIG. 86) rotary comb-drives. It should be appreciated that the SIM mirror configuration can be utilized with any of the mirror actuators described, other actuator designs, or combinations thereof, without departing from the teachings of the present invention.

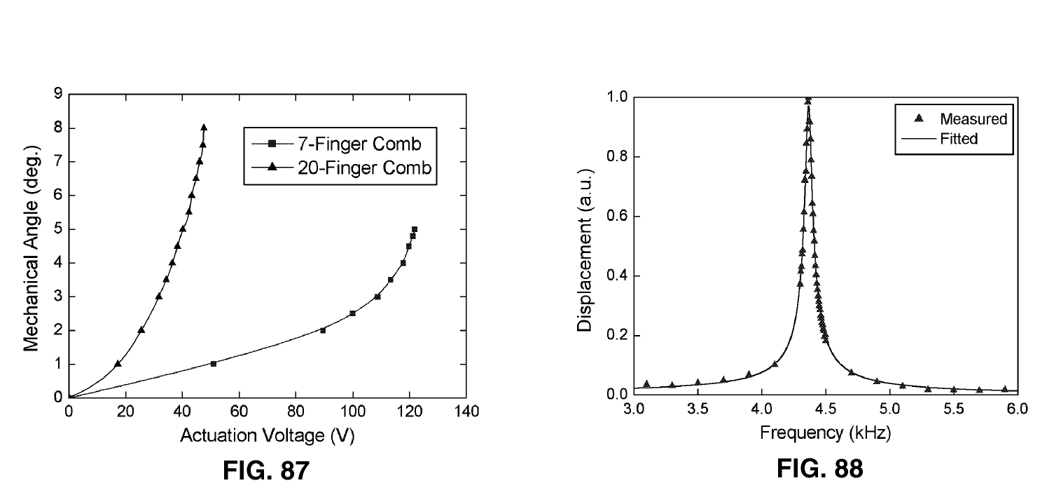

FIG. 87 depicts DC characteristics of the micromirrors shown fabricated in FIG. 85-86, which were tested by applying a DC bias across the moving and stationary combs. The maximum mechanical scan angle is 5° for the 7-finger comb-drive at 122V bias, and 8° for the 20-finger comb-drive at 48V bias.

FIG. 88 shows the stroboscopic measurement of the resonant frequency for the SIM with 7-finger comb-drive. The measured 4.37 kHz is lower than the calculated 5.34 kHz. The discrepancy could be due to the reduced spring width after fabrication.

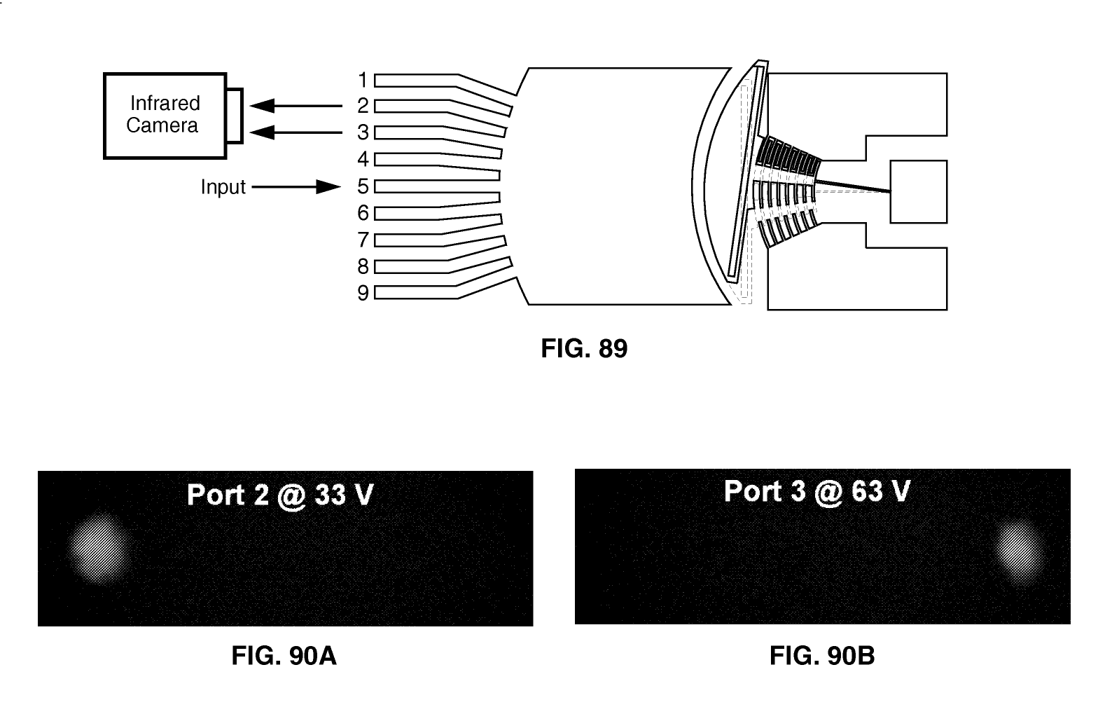

FIG. 89 illustrates an integrated chip with an array of waveguides in a fan-shaped layout for testing optical functionality. It should be noted that this test arrangement is similar to the arrangement of FIG. 46. The input signal (λ=1550 nm) at the central port (Port 5) was switched to Port 2 and Port 3 at 33V and 64V, respectively.

FIG. 90A-90B illustrate the infrared (IR) images of the optical beam observed at the output ports, thus verifying the dynamic switching capability of the SIM.

### CONCLUSION

We have developed a monolithic MEMS-based 1×4 wavelength-selective switch (WSS). Optical waveguides, microgratings, curved reflectors, as well as MEMS active switching micromirrors which are monolithically fabricated on a 2×1.4 cm² silicon-on-insulator (SOI) chip using a one-step etching process. The optical path is predefined by photolithography, eliminating the need for optical alignment or assembly.

An embodiment of a monolithic 1×4 WSS was experimentally characterized with a fiber-to-fiber insertion loss of 11.7 dB, and a crosstalk less than −27 dB, with a switching time of 0.5 msec. The on-chip micromirror with rotary comb-drive actuator was fabricated with a pitch of 400 μm for a coarse WDM (CWDM) with 20 nm channel spacing. A maximum mechanical scan angle of 7.4° has been achieved at a voltage bias of 101V. An alternative design of the micromirror with lateral comb-drive actuator was developed with a pitch of 75 μm for dense WDM (DWDM) with 0.8 nm (100 GHz) channel spacing. A maximum mechanical angle of 6.5° has been achieved at a voltage bias of 190 V. Moreover, the solid immersion micromirror with approximately 3.5 times enhancement of the effective optical scan angle has been developed.

An embodiment of a 4×4 wavelength-selective cross connect (WSXC) is also described by integrating four 1×4 multimode interference (MMI) splitters and four 4×1 WSSs on a 3.2×4.6-cm² SOI chip. Optical waveguides were used to connect the MMI splitters and the WSSs. Insertion loss and crosstalk are minimized using 90° waveguide bends (R=100 μm) and 90° waveguide crossings. The WSXC supports unicast, multicast, and broadcast functions. The monolithic 4×4 WSXC has been experimentally characterized with a fiber-to-fiber insertion loss of 24 dB, and a crosstalk less than −25 dB. Six CWDM passbands are demonstrated from 1460 nm to 1580 nm.

An alternative design of monolithic WSS was also described as being achieved by integrating the micromirror with arrayed-waveguide gratings (AWGs) on SOI platform. The key element has been demonstrated with a 1×8 optical switch on a hybrid PLC-MEMS platform. The switch is integrated with a microfabricated cylindrical lens, eliminating the need for external bulk lenses. The switch has been experimentally characterized with a fiber-to-fiber insertion loss of 3.9±0.2 dB, and a crosstalk less than −22 dB. The wavelength dependent loss over C-band (1530-1565 nm) is less than 0.1 dB, with a switching time was 0.5 msec.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Device Parameters Of The Monolithic 1 × 4 WSS

| System | Wavelength Range | 1470-1610 | nm |
|---|---|---|---|
| | Channel Spacing | 20 | nm |
| Waveguide | Dimension | 5 μm × 5 μm | |
| | Pitch | 250 | μm |
| Collimating Reflector | Effective Focal Length | 426 | μm |
| | Dimension | 125 μm × 125 μm | |
| Micrograting | Grating Period | 4.45 | μm |
| | Grating Order | 14 | |
| | Incident Angle | 45° | |
| | Diffraction Angle | 45° | |
| | Angular Dispersion | 0.074°/nm | |
| | FSR | 111 | nm |
| Focusing Reflector | Effective Focal Length | 15.5 | mm |
| | Dimension | 5 mm × 5 mm | |
| Micromirror | Mirror Pitch | 400 | μm |

| | |
|---|---|
| Fill Factor | 97.5% |
| Mechanical Scan Angle | 4.8° |

TABLE 2
Calculated Free Carrier Absorption In Si With N-Type Dopant

| Resistivity (Ω-cm) | N_{D} (cm⁻³) | α (dB/cm) |
|---|---|---|
| 100 | 4.3 × 10¹³ | 0.002 |
| 10 | 4.5 × 10¹⁴ | 0.016 |
| 1 | 4.9 × 10¹⁵ | 0.18 |
| 0.1 | 7.8 × 10¹⁶ | 2.9 |
| 0.01 | 4.5 × 10¹⁸ | 167 |

TABLE 3
Breakdown Of Insertion Loss Of The 1 × 4 WSS

| | | Theoretical | |
|---|---|---|---|
| | Mea- | (Current | Theoretical |
| Source of Losses | sured | Design) | (Fundamental) |
| Fiber Coupling ×2 | 2.3 | 1.3 | 0.2 |
| Grating ×2 | 6 | 2 | 0 |
| Sidewall Effect ×8 | 0.5 | 0 | 0 |
| Diffraction | 2.8 | 2.3 | 0.8 |
| (Air Gap for | | (10 μm gap) | (5 μm gap) |
| Micromirror) | | | |
| Fresnel Loss ×4 | 0.4 | 0.4 | 0 |
| (Imperfect AR | | | |
| Coating) | | | |
| 1 × 4 Loss | 12 | 6.0 | 1.0 |

TABLE 4
Measured And Theoretical Insertion Loss Of The Micrograting

| | | Double Pass Loss | | |
|---|---|---|---|---|
| Grating | Period | | Simulated with | Simulated with |
| Order | (μm) | Measured | Sharp Corner | Round Corner |
| 9 | 2.865 | 12.3 | 4.5 | 12.1 |
| 11 | 3.500 | 9.7 | 3.8 | 7.2 |
| 14 | 4.455 | 6.0 | 2.0 | 6.0 |
| 18 | 5.728 | 6.3 | 1.7 | 5.5 |
| 22 | 7.000 | 4.9 | 2.4 | 4.6 |
| 27 | 8.590 | 4.1 | 2.0 | 3.4 |
| 31 | 9.865 | 4.1 | 1.9 | 3.4 |
| 36 | 11.455 | 3.8 | 1.9 | 3.5 |
| 40 | 12.728 | 3.3 | 1.6 | 2.9 |
| 44 | 14.000 | 3.0 | 1.6 | 2.9 |

TABLE 5
Breakdown Of Insertion Loss Of The 4 × 4 WSXC

| | | Theoretical | |
|---|---|---|---|
| Source of Losses | Measured | Current Design | Fundamental |
| 1 × 4 WSS Loss | 12 | 6.0 | 1.0 |
| Waveguide Bending ×4 | 2 | 4 | 0 |
| Waveguide Crossing ×10 | 0.5˜1 | 0.2 | 0.2 |
| MMI Splitting Loss | 7.5˜9 | 6 | 6 |
| Total 4 × 4 WSXC Loss | 22˜24 | 16.2 | 7.2 |
| 4 × 4 WSXC Excess Loss | 16˜18 | 10.2 | 1.2 |

TABLE 6
Parameters of the monolithic MEMS-based 1 × 4 WSS

| Application | CWDM | | DWDM | |
|---|---|---|---|---|
| Channel Spacing (Δλ) | 20 | nm | 0.8 | nm |
| Number of Channels (K) | 8 | | 40 | |
| Port Count | 1 × 4 | | 1 × 4 | |
| Waveguide Dimensions | 5 × 5 | μm² | 5 × 5 | μm² |
| Focal Length of Collimating Reflector (f₁) | 426 | μm | 7.4 | mm |
| Confinement Factor of Collimating | 4 | | 4 | |
| Reflector (ξ_{c}) | | | | |
| Width of Collimating Reflector (D_{c}) | 125 | μm | 2.2 | mm |
| Pitch of Collimating Reflector (P_{c}) | 250 | μm | 2.2 | mm |
| Grating Angular Dispersion (D) | 0.074°/nm | | 0.074°/nm | |
| Focal Length of Focusing Reflector (f₂) | 15.5 | mm | 72.6 | mm |
| Width of Focusing Reflector (D_{f}) | 4.2 | mm | 11.8 | mm |
| Micromirror Pitch (Pₘ) | 400 | μm | 75 | μm |
| Confinement Factor of Micromirror (ξₘ) | 5.5 | | 4 | |
| Mechanical Scanning Angle | 4.8° | | 9.2° | |
| Operation Temperature | ±36° | C. | ±1.2° | C. |

What is claimed is:

1. A wavelength-selective switch for switching optical signals, comprising:
an optical input port for receiving a wavelength division multiplexed (WDM) light beam;
at least one dispersive element to demultiplex the WDM light beam for producing a plurality of demultiplexed light beams;
a plurality of optical output ports for transmitting multiplexed light beams; and
a mirror array configured for redirecting each of said demultiplexed light beams to said optical output ports;
wherein said optical input and output ports comprise optical waveguides which are integrated with the above elements on the same monolithic substrate.

2. A wavelength-selective switch as recited in claim 1, wherein said at least one dispersive element comprises at least one diffraction grating.

3. A wavelength-selective switch as recited in claim 2, wherein said diffraction grating comprises an array of trenches.

4. A wavelength-selective switch as recited in claim 3, wherein said array of trenches comprises triangular shaped trenches.

5. A wavelength-selective switch as recited in claim 1, wherein said mirror array comprises an array of integrated moveable mirrors.

6. A wavelength-selective switch as recited in claim 5, wherein said mirror array comprises a reflective structure whose angular position is modulated by actuators.

7. A wavelength-selective switch as recited in claim 6, wherein said actuators comprise linear or rotary electrostatic comb-drives.

8. A wavelength-selective switch as recited in claim 1, further comprising means for collimating light beams.

9. A wavelength-selective switch as recited in claim 8, wherein said means for collimating light beams comprises curved mirrors fabricated on the same substrate as said optical waveguides.

10. A wavelength-selective switch as recited in claim 9, wherein said integrated curved mirrors comprise etched curved trenches fabricated on the same substrate as said optical waveguides.

11. A wavelength-selective switch as recited in claim 1, further comprising at least one imaging component to direct said demultiplexed light beams onto said mirror array, and fabricated on the same monolithic substrate.

12. A wavelength-selective switch as recited in claim 11, wherein said at least one imaging component comprises at least one curved mirror.

13. A wavelength-selective switch as recited in claim 12, wherein said curved mirrors comprise etched curved trenches.

14. A wavelength-selective switch as recited in claim 1, wherein said monolithic substrate comprises silicon, silicon-on-insulator, silica-on-silicon, or a PLC material.

15. A wavelength-selective switch as recited in claim 1, wherein said wavelength-selective switch is integrated within a wavelength selective cross-connect (WSXC) device.

16. A wavelength-selective switch as recited in claim 1, wherein said wavelength-selective switch is a 1×N optical switch, and operates bi-directionally as an N×1 optical switch.

17. A wavelength-selective switch as recited in claim 1, wherein said dispersive element comprises an array waveguide grating (AWG).

18. A wavelength-selective switch as recited in claim 1, wherein optical waveguides direct said light beams onto said monolithic substrate and between the integrated optical elements and comprises intersecting optical waveguides.

19. A wavelength-selective switch as recited in claim 1, further comprising:
means for collimating light beams; and
at least one imaging component to direct said demultiplexed light beams onto said switching elements;
wherein said means for collimating light beams, said dispersive element, said at least one imaging component, and said switching elements are arranged in a 4-f confocal configuration on said monolithic substrate; and
wherein said means for collimating light beams is positioned a 1-f distance from said optical input ports and 3-f from said switching elements.

20. A wavelength-selective switch for switching optical signals within a monolithic device, comprising:
a first waveguide configured for receiving a wavelength division multiplexed (WDM) light beam;
a first dispersive element to demultiplex the WDM light beam received from said first waveguide into a plurality of demultiplexed light beams;
at least one collimating element;
an array of movable mirrors configured for receiving light beams from said at least one collimating element and redirecting light beams through said at least one collimating element;
each of said movable mirrors comprising a reflective structure whose angular position is modulated in response to electrostatic actuation of linear or rotary comb-drives; and
at least a second and third waveguide configured for receiving light redirected from said array of movable mirrors through said at least one collimating element;
wherein the elements of the wavelength-selective switch are fabricated within a monolithic device.

21. A wavelength-selective switch for switching optical signals within a monolithic device, comprising:
a first waveguide configured for receiving a wavelength division multiplexed (WDM) light beam;
a first dispersive element configured for demultiplexing the light beam received from said first waveguide into a plurality of demultiplexed light beams;
at least one collimating element;
an array of movable mirrors configured for receiving light beams from said at least one collimating element and redirecting light beams through said at least one collimating element;
each of said movable mirrors comprising a solid immersion micromirror (SIM), said movable mirror configured for angular position modulation in response to actuation of electrostatic comb-drives; and
at least a second and third waveguide configured for receiving light redirected from said array of movable mirrors through said at least one collimating element;
wherein the elements of the wavelength-selective switch are fabricated on a planar lightwave circuit material having an optically transparent layer through which said optical signals are communicated.
